(19) United States
(12) Patent Application Publication
(10) Pub. No.: US 2026/0077369 A1
(43) Pub. Date: Mar. 19, 2026

(54) MOBILE SPRAY SYSTEM

(71) Applicant: Design West Technologies, Inc., Tustin, CA (US)

(72) Inventors: Maria Bauer, Tustin, CA (US); Sam De La Torre, Tustin, CA (US); William Mao, Tustin, CA (US); So Nguyen, Tustin, CA (US); Ryan Hur, Tustin, CA (US)

(73) Assignee: Design West Technologies, Inc., Tustin, CA (US)

(21) Appl. No.: 19/329,401

(22) Filed: Sep. 15, 2025

Related U.S. Application Data
(60) Provisional application No. 63/694,746, filed on Sep. 13, 2024.

(51) Int. Cl. B05B 9/04; B05B 12/00

(52) U.S. Cl. CPC B05B 9/0406; B05B 9/0416; B05B 12/002

(57) ABSTRACT

A spray system includes a fluid tank assembly with a reservoir defining a fluid storage volume and a fluid pump system releasably connectable to the reservoir. The fluid pump system comprises a pump, an inlet configured to receive fluid from the reservoir and an outlet configured to deliver pressurized fluid to a spray nozzle. A releasable coupling mechanism establishes fluid communication between the reservoir and the pump when engaged and allows for tool-less disconnection for maintenance, cleaning or replacement. The system permits rapid detachment of the pump from the tank assembly, enhancing portability, refilling convenience, and ease of servicing.

### RELATED APPLICATIONS

This application claims benefit of and priority to U.S. Provisional Application Ser. No. 63/694,746 filed Sep. 13, 2024 entitled Mobile Spray System, which is hereby incorporated herein by reference in.

### BACKGROUND

Mobile spray systems typically include a fluid tank and pump mechanism that allow a user to spray fluids through a nozzle for various purposes. In some use cases such as military use, industrial use, or commercial use, existing spray systems may have a variety of disadvantages, such as not producing adequate fluid spray velocity and volume, inefficient fluid tank filling, a lack of a durable design, and an overall lack of features for flexible usage needs.

In one example use scenario, a mobile spray system may be used for Chemical Biological Radiological and Nuclear (CBRN) decontamination needs (e.g., military usage) in far-forward environments. For example, these decontamination systems are often required to reduce contamination levels on equipment, especially for chemical and biological threats, to a concentration where it is safe for personnel to use equipment and vehicles without personal protective equipment. In military usage, relatively large spray distance/height may be needed to reach areas such as aircraft tail fins and similar equipment, or even to spray personnel. Depending on the need, the sprayed fluid may contain relatively harsh chemicals and/or fluid containing particles (e.g., Zr) that can damage pumping components of a spray system. Depending on the situation (e.g., decontamination), time may be of importance and therefore the ability to both quickly spray and fill a spray system with fluid can be valuable. Further, the ability to easily transport a spray system around a specific site or between long distances on vehicles may also be valuable.

### SUMMARY

In some aspects, the techniques described herein relate to a spray system, including: a fluid tank assembly; and, a fluid pump system that is releasably connected to the fluid tank assembly.

In some aspects, the techniques described herein relate to a spray system, wherein the fluid tank assembly includes a fluid tank having a fluid cavity, a first fluid connection, and a second fluid connection.

In some aspects, the techniques described herein relate to a spray system, wherein the fluid pump system includes a fluid pump assembly including a first pump and a second pump.

In some aspects, the techniques described herein relate to a spray system, wherein the first pump and the second pump are both gear pumps.

In some aspects, the techniques described herein relate to a spray system, wherein the first pump and the second pump each have first and second fluid connections into passages of a manifold block.

In some aspects, the techniques described herein relate to a spray system, wherein the fluid pump assembly includes a first valve and a second valve, both located within the manifold block and arranged to open and close portions of the passages of the manifold block.

In some aspects, the techniques described herein relate to a spray system, wherein the first valve and the second valve are each a cylindrical valve member that have three openings into a valve passage therethrough.

In some aspects, the techniques described herein relate to a spray system, further including a connection assembly that releasably connects the fluid pump system to the fluid tank assembly; the connection assembly including a latch mechanism and two fluid disconnect fittings in communication with the fluid tank.

In some aspects, the techniques described herein relate to a spray system, wherein the connection assembly further includes a slot through a support plate and an alignment rail movable into and out of the slot.

In some aspects, the techniques described herein relate to a spray system, wherein the fluid pump system is configured to simultaneously fill the fluid tank from a first hose and spray fluid from a second hose.

In some aspects, the techniques described herein relate to a spray system, wherein the fluid pump system is further configured to circulate fluid into and out of the fluid tank.

In some aspects, the techniques described herein relate to a spray system, including: a fluid tank assembly; a fluid pump system; a connection assembly configured to releasably connect the fluid pump system to the fluid tank assembly, the connection assembly including a mechanical latch and at least two fluid disconnect fittings; a flow-routing component configurable among a plurality of flow states to direct fluid between the fluid tank assembly, a supply line, and a spray outlet; a user interface including a set of one-button function triggers; and an electronic controller operatively coupled to the user interface, the flow-routing component, and the fluid pump system; wherein, in response to actuation of any one of the one-button function triggers, the controller automatically configures the flow-routing component and energizes a selected pump or pumps to execute a corresponding function without further user selections.

In some aspects, the techniques described herein relate to a spray system, wherein the connection assembly further includes a slot through a support plate and an alignment rail movable into and out of the slot to guide attachment and detachment.

In some aspects, the techniques described herein relate to a spray system, wherein the fluid pump system includes first and second pumps mounted to a manifold block having passages coupled to fluid disconnect fittings.

In some aspects, the techniques described herein relate to a spray system, wherein the first and second pumps are gear pumps.

In some aspects, the techniques described herein relate to a spray system, wherein a flow-routing component is selected from the group consisting of a rotary valve, a spool valve, a shuttle valve, and a manifold of on/off valves operated by a single actuator.

In some aspects, the techniques described herein relate to a spray system, wherein a controller is configured to simultaneously fill the fluid tank assembly from a first hose and spray fluid from a second hose by commanding a flow-routing component and the pumps accordingly.

In some aspects, the techniques described herein relate to a spray system, wherein a controller is further configured to circulate fluid into and out of the fluid tank assembly as a selectable function.

In some aspects, the techniques described herein relate to a spray system, wherein a user interface further includes a display that renders a pictogram indicative of an active function and a progress indicator during execution.

In some aspects, the techniques described herein relate to a spray system, wherein the fluid tank assembly includes a fluid tank having a fluid cavity, a first fluid connection, and a second fluid connection, each in fluid communication with fluid disconnect fittings when connected.

In some aspects, the techniques described herein relate to a three-way, four-position rotary valve assembly, including: a stationary valve body having three fixed ports; a rotatable valve member disposed within the stationary valve body, the rotatable valve member defining a T-shaped flow passage with three openings configured to re-register with the three fixed ports; a motor operatively coupled to rotate the rotatable valve member through 360° about a central axis; a magnetic element fixed to rotate with the rotatable valve member; four Hall-effect sensors arranged circumferentially about the central axis; and a control printed circuit board (PCB) in signal communication with the Hall-effect sensors and the motor; wherein the valve assembly is indexable to four discrete flow states separated by about 90° of rotation, each flow state establishing a distinct connection pattern among the three fixed ports.

In some aspects, the techniques described herein relate to a valve assembly, wherein the four Hall-effect sensors are positioned at angular locations corresponding to the four flow states.

In some aspects, the techniques described herein relate to a valve assembly, wherein the magnetic element includes a permanent magnet mounted to a magnetic ring fixed to a shaft of the motor or the rotatable valve member.

In some aspects, the techniques described herein relate to a valve assembly, wherein the control PCB determines an angular position of the rotatable valve member based on outputs of the four Hall-effect sensors, commands the motor to align the rotatable valve member with a selected one of the four flow states, and provides real-time position feedback.

In some aspects, the techniques described herein relate to a valve assembly, wherein the Hall-effect sensors and the magnetic element are arranged for non-contact sensing, enabling the valve assembly to be sealed for moisture protection.

In some aspects, the techniques described herein relate to a valve assembly, wherein the four Hall-effect sensors are equally spaced at approximately 90° intervals around the central axis.

In some aspects, the techniques described herein relate to a valve assembly, wherein the control PCB is configured to execute a control method including: receiving a command identifying a target one of the four flow states; driving the motor to rotate the rotatable valve member; sampling, during the rotation, signal amplitudes from the Hall-effect sensors as the magnetic element passes each sensor and produces a low-to-high-to-low waveform; computing a slope (first derivative) of at least one sampled Hall-effect signal and detecting a zero-slope condition indicative of on-target alignment with the target flow state; and stopping the motor in response to detecting the zero-slope condition.

In some aspects, the techniques described herein relate to a valve assembly, wherein the control PCB applies filtering and/or hysteresis to the Hall-effect signals prior to computing the slope to reduce noise sensitivity.

In some aspects, the techniques described herein relate to a valve assembly, wherein the control PCB adjusts stop timing based on a measured sign change of the slope around the zero-slope condition to compensate for temperature-or friction-induced variation.

In some aspects, the techniques described herein relate to a valve assembly, wherein the control PCB periodically performs a calibration by rotating through the four flow states to update a reference profile of Hall-effect signal versus angle.

In some aspects, the techniques described herein relate to a valve assembly, wherein rotation by approximately 0°, 90°, 180°, and 270° produces the four discrete flow states.

### BRIEF DESCRIPTION OF THE DRAWINGS

The following figures are included to illustrate certain example aspects of the present disclosure and should not be viewed as exclusive or limiting. The subject matter disclosed is capable of considerable modifications, alterations, combinations, and equivalents in form and function, as will occur to one having ordinary skill in the art and having the benefit of this disclosure. The present disclosure references the drawings as follows:

FIG. 1 illustrates an isometric view of a mobile spray system that includes several features that provide improved pumping performance, improved mobility, and improved reliability, among other benefits.

FIG. 2 illustrates a side view of a hand-actuated spray nozzle that may be connected, via fluid tube, to the mobile spray system that may be used for spraying fluid or for pumping fluid into a fluid tank.

FIG. 3 illustrates another isometric view of the mobile spray system, FIG. 4 illustrates a front view of the mobile spray system, FIG. 5 illustrates a back view of the mobile spray system, FIG. 6 illustrates a side view of the, FIG. 7 illustrates another side view of the, FIG. 8 illustrates a top view of the mobile spray system, and FIG. 9 illustrates a bottom view of the.

FIG. 10 illustrates an isometric view of the fluid tank assembly.

FIG. 11 illustrates a magnified view of the front of the fluid tank assembly.

FIG. 12 illustrates another magnified view of the front of the fluid tank assembly.

FIG. 13 illustrates a back side of the fluid pump system which includes several components for making these connections, including a fluid pump assembly that electrically pumps fluid through the mobile spray system.

FIG. 14 illustrates an isometric view of a first side of some internal components of the fluid pump assembly.

FIG. 15 illustrates an isometric view of a second side of some internal components of the fluid pump assembly.

FIG. 16 illustrates an isometric view of a second side of some internal components of the fluid pump assembly.

FIG. 17 illustrates a cross-sectional view of some internal components of the fluid pump assembly.

FIG. 18 illustrates a view of a tapered bearing and a seal.

FIG. 19 illustrates a cross-sectional view of the tapered bearing.

FIG. 20 illustrates an isometric view of a manifold block.

FIG. 21 illustrates a top transparent view of the manifold block.

FIG. 22 illustrates a side view of a valve member.

FIG. 23A illustrates a top transparent view of the valve member.

FIG. 23B illustrates locations of Hall-effect sensors 1-4 relative to the valve member.

FIG. 23C illustrates sensor data from several Hall-effect sensors (e.g., 4 sensors).

FIG. 23D illustrates processed sensor data.

FIG. 24A illustrates a simplified schematic of the fluid passages of the manifold block, as well as each valve member, each valve motor, and the fluid tank to help illustrate some example configurations and functionalities of the mobile spray system in the following figures.

FIG. 24B illustrates a simplified schematic view of the mobile spray system in an off or powered down state.

FIG. 24C illustrates a simplified schematic view of the mobile spray system in a passthrough state in which fluid is sucked into the fluid pump system and sprayed out of the fluid pump system, bypassing the fluid tank.

FIG. 24D illustrates a simplified schematic view of the mobile spray system in a fill state in which fluid is pumped from outside of the fluid pump system and into the fluid tank.

FIG. 24E illustrates a simplified schematic view of the mobile spray system in a fill/spray state in which fluid outside of the fluid pump system is pumped into the fluid tank and fluid within the fluid tank is also simultaneously pumped out of the fluid tank to spray.

FIG. 24F illustrates a simplified schematic view of the mobile spray system in a recirculate state in which the fluid pump system pumps fluid out of the fluid tank and back into the fluid tank (e.g., to mix contents of the fluid tank).

FIG. 24G illustrates a simplified schematic view of the mobile spray system in which the fluid pump system pumps fluid from the fluid tank to spray.

FIG. 25 illustrates an isometric view of the mobile spray system.

FIG. 26 illustrates another isometric view of the mobile spray system.

FIG. 27 illustrates a top view of the mobile spray system.

FIG. 28 illustrates a bottom view of the mobile spray system.

FIG. 29 illustrates a front view of the mobile spray system.

FIG. 30 illustrates a back view of the mobile spray system.

FIG. 31 illustrates a side view of the mobile spray system.

FIG. 32 illustrates another side view of the mobile spray system.

FIG. 33 illustrates a top isometric view of the internal components of the fluid pump assembly.

FIG. 34 illustrates a bottom isometric view of the internal components of the fluid pump assembly.

FIG. 35 illustrates an isometric view of a manifold block.

FIG. 36 illustrates a transparent view of a manifold block.

FIG. 37A illustrates a simplified schematic of the fluid passages of the manifold block, as well as each valve member, each valve motor, the first fluid tank, and second fluid tank to help illustrate some example configurations and functionalities of the mobile spray system in the following figures.

FIG. 37B illustrates a simplified schematic view of the mobile spray system in an off or powered down state.

FIG. 37C illustrates a simplified schematic view of the mobile spray system in a bypass state that suctions fluid into and out of the fluid pump assembly while bypassing the first fluid tank and second fluid tank.

FIG. 37D illustrates a simplified schematic view of the mobile spray system in a tank-filling and spraying state.

FIG. 37E illustrates a simplified schematic view of the mobile spray system in a tank-filling.

FIG. 37F illustrates a simplified schematic view of the mobile spray system in a tank-filling and spraying state.

FIG. 37G illustrates a simplified schematic view of the mobile spray system in tank-filling and spraying state.

FIG. 37H illustrates a simplified schematic view of the mobile spray system in a tank-filling and spraying state.

FIG. 37I illustrates a simplified schematic view of the mobile spray system in a tank-filling and spraying state.

FIG. 37J illustrates a simplified schematic view of the mobile spray system in a tank filling and spraying state.

FIG. 37K illustrates a simplified schematic view of the mobile spray system in a filling state.

FIG. 37L illustrates a simplified schematic view of the mobile spray system in a filling and spraying state.

FIG. 37M illustrates a simplified schematic view of the mobile spray system in a recirculating state.

FIG. 37N illustrates a simplified schematic view of the mobile spray system in a recirculation state.

FIG. 37P illustrates a simplified schematic view of the mobile spray system in a spraying state.

FIG. 37Q illustrates a simplified schematic view of the mobile spray system in a spraying state.

FIG. 38 illustrates a view of a control panel and associated display.

### DETAILED DESCRIPTION

It will be appreciated by persons skilled in the art that the present disclosure is not limited to what has been particularly shown and described herein. A variety of modifications and variations are possible in view of the teachings herein without departing their scope, spirit, or intent.

While different examples may be described in this specification, it is specifically contemplated that any of the features from the different examples can be used and brought together in any combination. In other words, the features of different examples can be mixed and matched with each other. Hence, while every permutation of features from different examples may not be explicitly shown or described, it is the intention of this disclosure to cover any such combinations, especially as may be appreciated by one of skill in the art.

The terminology used in this disclosure should be interpreted in a permissive manner and is not intended to be limiting. In the drawings, like numbers refer to like elements. Unless otherwise noted, all of the accompanying drawings are not to scale. Unless otherwise noted, the term “about” is defined to mean plus-or-minus 5% of a stated value.

Numerical ranges discussed in this specification should be interpreted as both inclusive numerical ranges and as covering/disclosing a plurality of numbers within the ranges. Specifically, a range should be considered to recite numbers that increment by two decimal places (hundredths) for the purposes of support in the claims (e.g., 0.01, 0.02, 0.03, etc.). Any of these incremented numbers from a range should be understood to have significance and importance in the context of the present specification.

Mobile spray systems typically include a fluid tank and pump mechanism that allow a user to spray fluids through a nozzle for various purposes. In some use cases such as military use, industrial use, or commercial use, existing spray systems may have a variety of disadvantages, such as not producing adequate fluid spray velocity and volume, inefficient fluid tank filling, a lack of a durable design, and an overall lack of features for flexible usage needs.

In one example use scenario, a mobile spray system may be used for Chemical Biological Radiological and Nuclear (CBRN) decontamination needs (e.g., military usage) in far-forward environments. For example, these decontamination systems are often required to reduce contamination levels on equipment, especially for chemical and biological threats, to a concentration where it is safe for personnel to use equipment and vehicles without personal protective equipment. In military usage, relatively large spray distance/height may be needed to reach areas such as aircraft tail fins and similar equipment, or even to spray personnel. Depending on the need, the sprayed fluid may contain relatively harsh chemicals and/or fluid containing particles (e.g., Zr) that can damage pumping components of a spray system. Depending on the situation (e.g., decontamination), time may be of importance and therefore the ability to both quickly spray and fill a spray system with fluid can be valuable. Further, the ability to easily transport a spray system around a specific site or between long distances on vehicles may also be valuable.

The present specification is directed to several example mobile spray systems that may include features to improve pumping performance, improve reliability, improve mobility, and improve efficiency, among other benefits. In certain examples, the system may include a one-button trigger whereby component actuation is automated, enabling user focus on application rather than system setup. While the example mobile spray systems may be described as including different features, it should be understood that these features may be mixed and matched between designs. Hence, any particular feature should not be limited to only the example design it is described on.

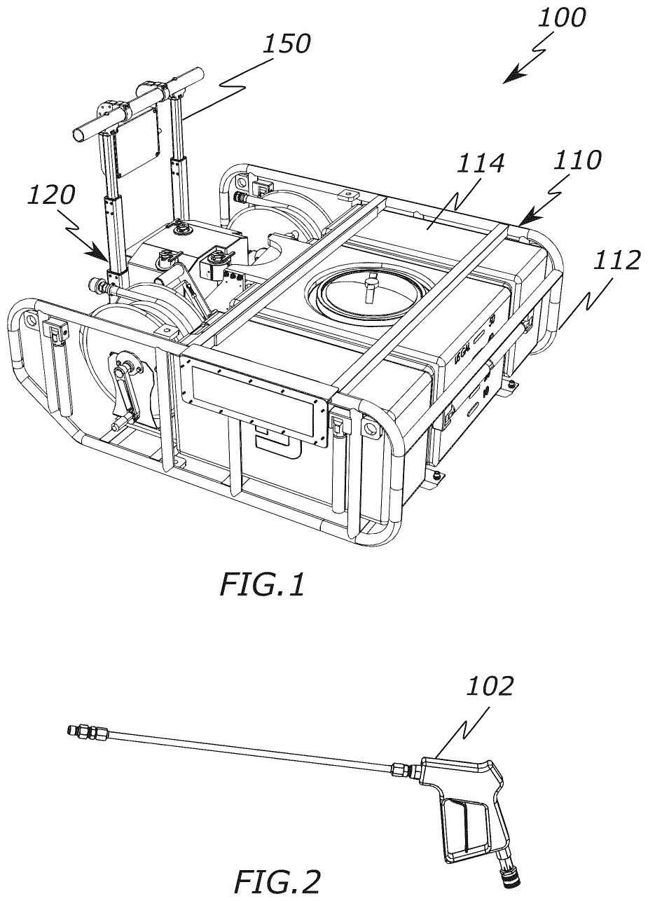

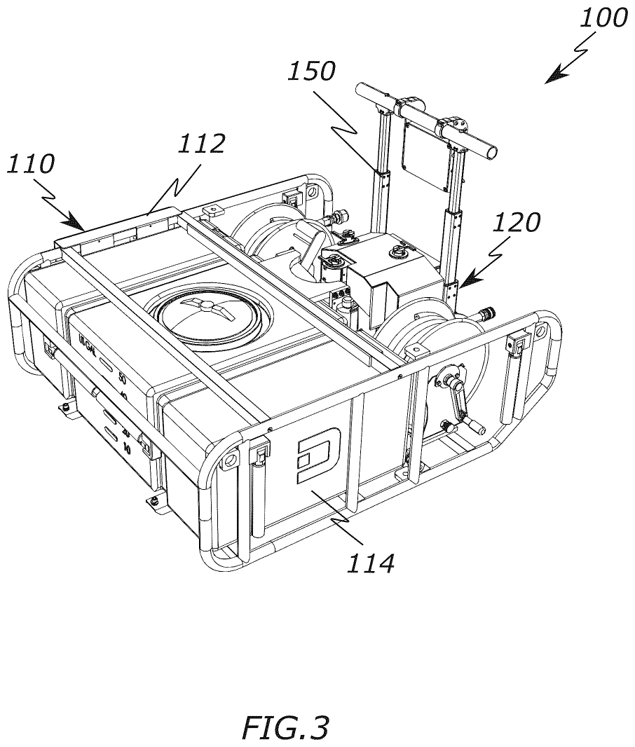

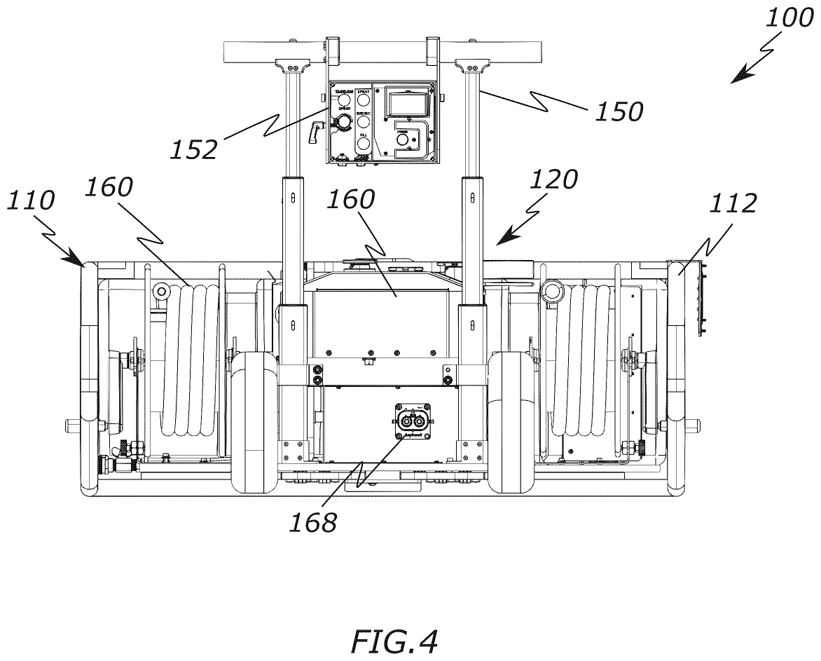

FIG. 1 illustrates an isometric view of a mobile spray system 100 that includes several features that provide improved pumping performance, improved mobility, and improved reliability, among other benefits. FIG. 2 illustrates a side view of a hand-actuated spray nozzle 102 that may be connected, via fluid tube, to the mobile spray system 100 that may be used for spraying fluid or for pumping fluid into a fluid tank 114. FIG. 3 illustrates another isometric view of the mobile spray system 100, FIG. 4 illustrates a front view of the mobile spray system 100, FIG. 5 illustrates a back view of the mobile spray system 100, FIG. 6 illustrates a side view of the 100, FIG. 7 illustrates another side view of the 100, FIG. 8 illustrates a top view of the mobile spray system 100, and FIG. 9 illustrates a bottom view of the 100. These Figures are discussed concurrently below.

The mobile spray system 100 may include a fluid tank assembly 110 and a fluid pump system 120. As discussed in further detail below, the fluid pump system 120 is connectable to and separable from the fluid tank assembly 110 in a modular manner, allowing a user to quickly connect the fluid pump system 120 to the fluid tank assembly 110 and, if needed, release the fluid pump system 120 from the fluid tank assembly 110 (e.g., for connection to a different fluid tank assembly 110). This modular spray system may provide several advantages. For example, a user may have a plurality of fluid tank assemblies 110 (e.g., at different locations) and only a single fluid pump system 120 that can be moved between each of the fluid tank assemblies 110 as needed. Since the fluid tank assembly 110 may be relatively heavy when filled with fluid and the fluid pump system 120 may be relatively easy to move by hand (e.g., with wheels 159), the ability to station multiple fluid tank assemblies 110 as specific locations can provide a significant savings of time and effort. Additionally, the fluid pump system 120 may be used without the fluid tank assembly 110 to simultaneously suction fluid from a source (e.g., pond or other container) and spray.

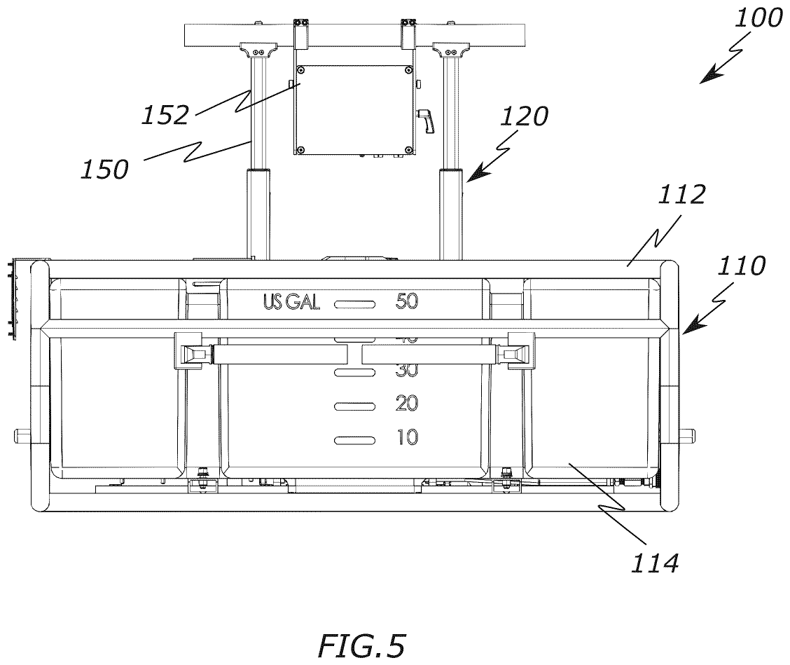

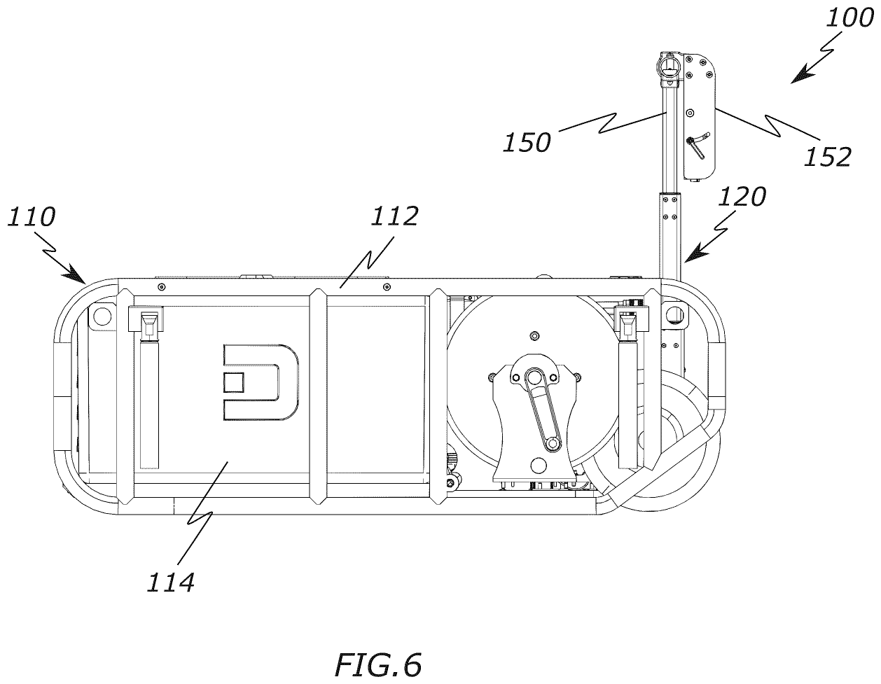

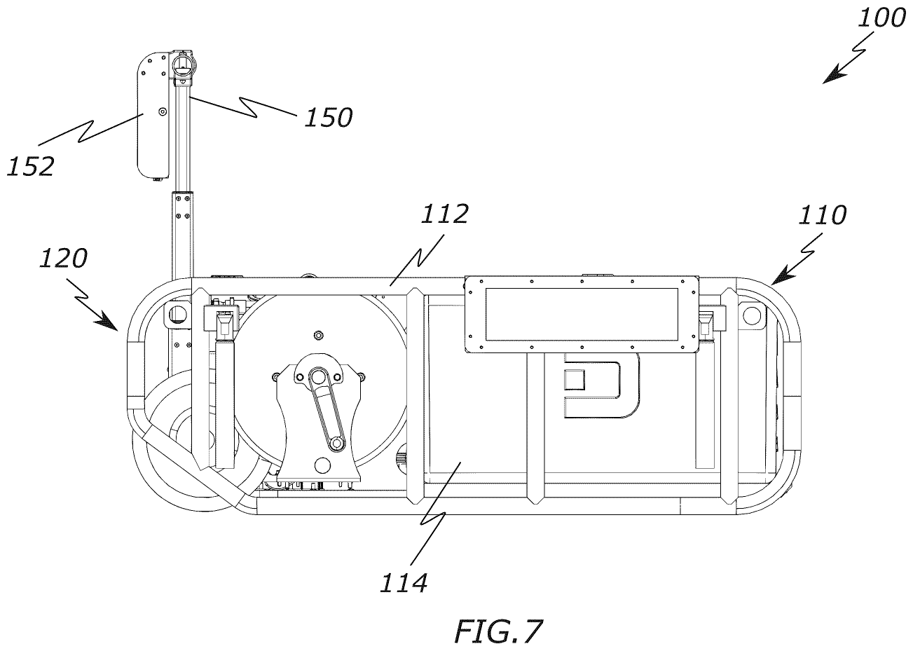

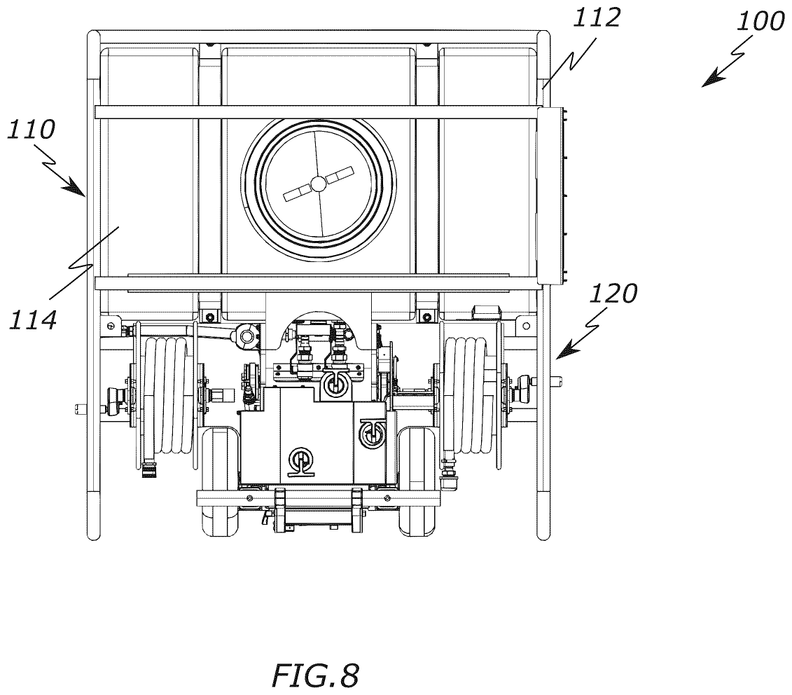

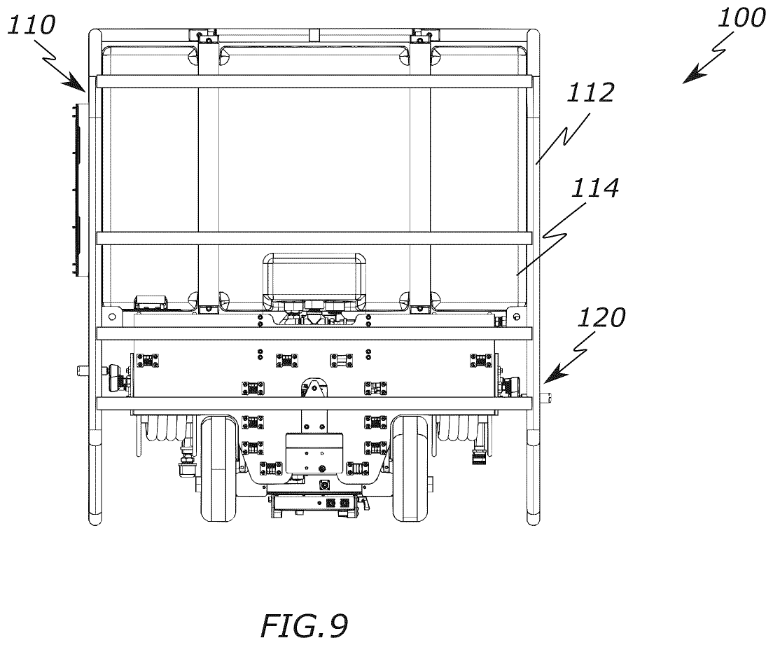

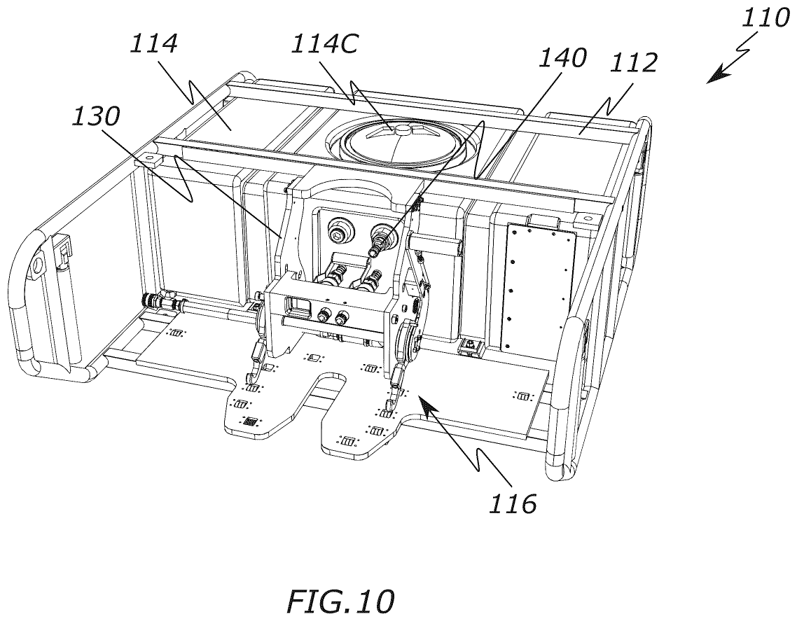

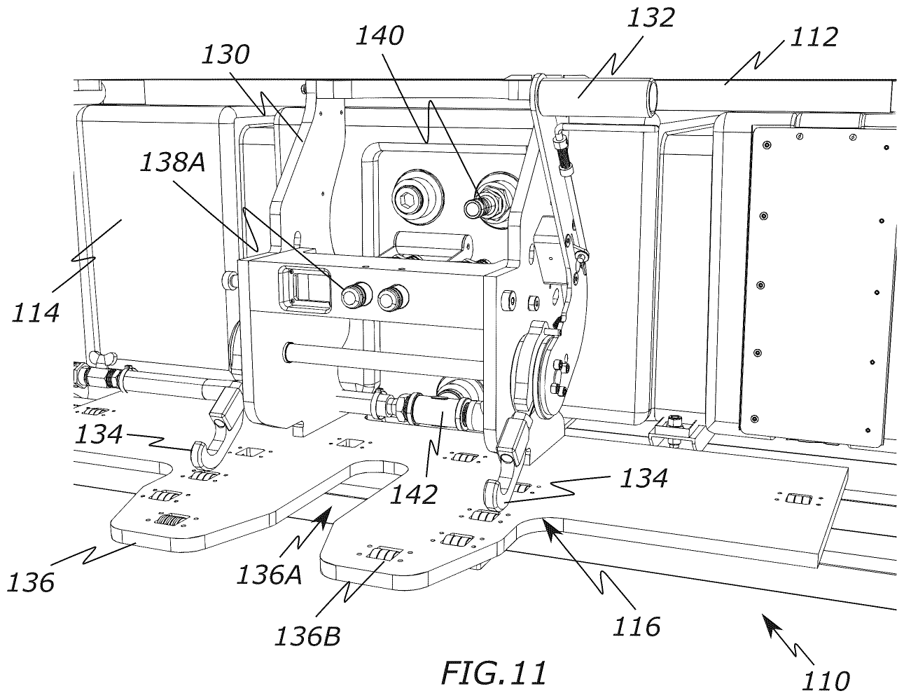

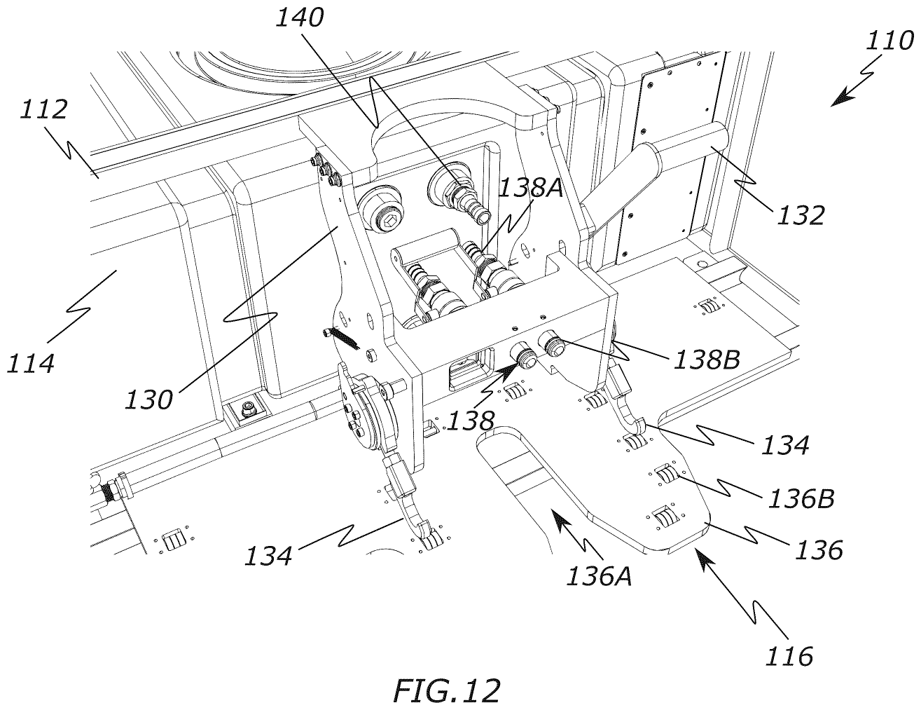

FIG. 10 illustrates an isometric view of the fluid tank assembly 110, FIG. 11 illustrates a magnified view of the front of the fluid tank assembly 110, and FIG. 12 illustrates another magnified view of the front of the fluid tank assembly 110. In some examples, the fluid tank assembly 110 may include a fluid tank 114, a structural frame 112, and a connection assembly 116 that releasably connects to the fluid pump system 120.

The fluid tank 114 may be an enclosed container that is suitable for holding and containing various fluids. In the present example, the fluid tank 114 may have a generally rectangular cuboid shape, as seen in the figures. However, other shapes are also possible, such as cube shapes, or other polyhedral shapes. The fluid tank 114 may have a variety of different sizes, such as 10 gallons, 50 gallons, 75 gallons, or 100 gallons.

The fluid tank 114 may have one or more openings into its interior. For example, a top surface may have a removable cover 114C which allows a user to pour fluid and/or other additives into the interior of the fluid tank 114. In another example, the fluid tank 114 may have one or more openings that connect to the fluid pump system 120. As best seen in FIG. 11, the fluid tank 114 may include a top fitting 140 and a bottom fitting 142 that both open into an interior of the fluid tank 114. In the present example, the bottom fitting 142 is connected to a “T” tube that splits into a connection end (hidden in FIG. 11) and a drain valve at the other end for selectively draining a fluid tank 114, if necessary. In some examples, having two connections to the fluid pump system 120 (i.e., top fitting 140 and bottom fitting 142) may allow the fluid pump system 120 to recirculate fluid within the structural frame 112 by removing it and re-adding it back to the structural frame 112. This may be important if the fluid contains particles, is a solution, requires mixing, or other scenarios.

The structural frame 112 may be composed of a plurality of structural members, such as beams, tubes, or other rigid structures, that are connected to each other to at least partially surround the fluid tank 114. In the present example, the structural frame 112 forms a generally rectangular cuboid that may extend beyond the fluid tank 114 in some areas, such as the area near or partially surrounding the connection assembly 116. However, other shapes (e.g., cubical) are also possible. The structural frame 112 may provide additional structural support that may, for example, protect the fluid tank 114 if another fluid tank assembly 110 (or other equipment) is stacked on top. It also may provide a manner and location for the connection assembly 116 to be fixed in near proximity to the fluid tank 114.

The connection assembly 116 may provide a mechanism for both releasably physically connecting or locking to the fluid pump system 120 and for facilitating a fluidic connection between the fluid pump system 120 and the interior of the fluid tank 114.

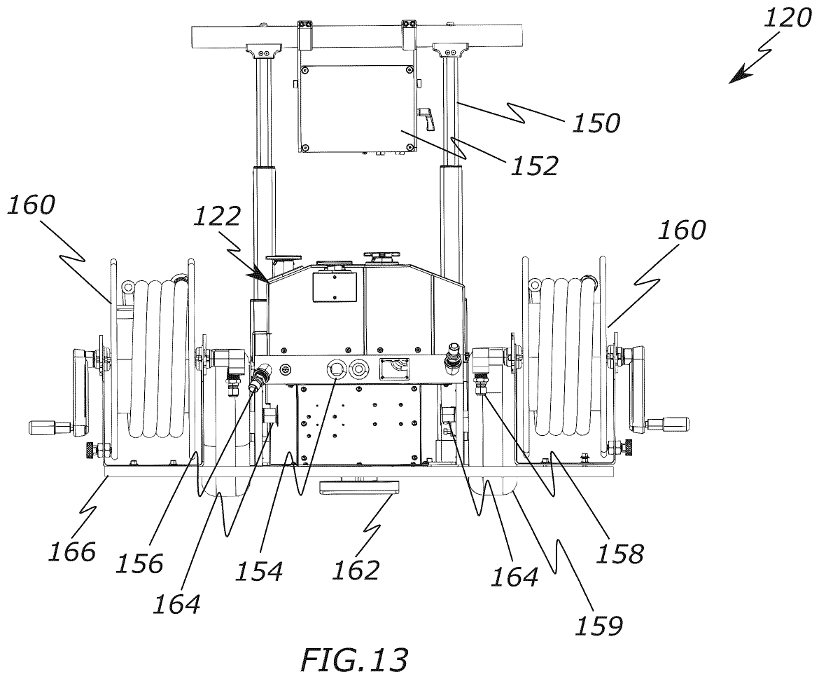

FIG. 13 illustrates a back side of the fluid pump system 120 which includes several components for making these connections, including a fluid pump assembly 122 that electrically pumps fluid through the mobile spray system 100. The fluid pump system 120 may be moved or pushed by hand with the handle 150 (e.g., a telescoping handle) and wheels 159, though other mechanisms to facilitate movement are also or alternatively possible, such as connections for vehicles (e.g., forklift brackets).

The physical connection between the fluid pump system 120 and the fluid tank assembly 110 may be achieved with any releasable connection assembly. In the present example, a latching-style connection mechanism is used. A frame of the fluid pump system 120 may include at least one or two latch posts 164 (FIG. 13) that may be selectively engaged with latch hooks 134 (FIG. 11) that are pivotally connected on a framework 130 of the connection assembly 116. The latch hooks 134 may be actuated or moved, for example, by a handle 132 so that they hook or engage the latch posts 164. In the present example, the at least one or two latch posts 164 are oriented to a have a generally horizontal longitudinal axis and the latch hooks 134 may be oriented in a generally vertical plane, however, these orientations may be respectively reversed or may have different orientations. The inner/open curvature of the latch hooks 134 is positioned in a generally upward orientation so that it engages from a bottom of the at least one or two latch posts 164, however, the inner/open curvature may instead be positioned in a generally downward orientation as well. While two of the latch hooks 134 and at least one or two latch posts 164 are shown, a single pair, three pairs, four pairs, or more may alternatively be included, including at different orientations (e.g., some of the latch hooks 134 open downwards and other latch hooks 134 open upwards).

The handle 132 and the latch hooks 134 (connected here by a cross shaft) may be pivotally mounted. Additionally, it may be helpful for the latch hooks 134 to be connected in a cam arrangement so that when the handle 132 is moved, the latch hooks 134 move both backward (e.g., towards the fluid tank 114) and upward to better engage the at least one or two latch posts 164.

The connection assembly 116 may also include a bottom support plate 136 that the fluid pump system 120 slides onto. The bottom support plate 136 may include a mechanism that limits vertical movement of the fluid pump system 120 relative to the fluid tank assembly 110 and provides both vertical and horizontal alignment. For example, the bottom support plate 136 may include a slot 136A or channel that allows an alignment rail 162 (FIG. 13) to slide into. The alignment rail 162 may extend downward from a bottom surface of a bottom support plate 166 of the fluid pump system 120. The alignment rail 162 may a relatively narrower base portion connecting to the bottom support plate 166 and a wider free end. The free end of the alignment rail 162 may have a width that is wider than the slot 136A of the bottom support plate 136, while the base of the alignment rail 162 may have a width that is narrower than that of the 136A. This sizing allows the alignment rail 162 to slide into the slot 136A while the wider free end and bottom support plate 166 limit relative vertical movement of the alignment rail 162. Hence, the slot 136A helps vertically and horizontally align the fluid pump system 120 while the latch hooks 134 retain the fluid pump system 120 from moving away from the connection assembly 116.

Since portions of the bottom support plate 166 may slide against a top surface of the bottom support plate 136, in some examples it may be helpful to include a plurality of rollers 136B within grooves of the bottom support plate 136 or mounted on the surface of the bottom support plate 136 to reduce friction. Other mechanisms, such as low friction pads, are also possible.

The fluid connection between the fluid tank 114 and the fluid pump system 120 may be achieved, in one example, as follows. First, the top fitting 140 and bottom fitting 142 that connect with the interior of the fluid tank 114 may each be connected, via a hose or tube (not shown) to one of the two disconnect fittings 138. As seen best in FIG. 12, an inner facing portion 138A of the two disconnect fittings 138 may each be connected to such hoses, which creates a fluid path between outer facing portion 138B of each two disconnect fittings 138 and the interior of the fluid tank 114.

The fluid pump assembly 122 of the fluid pump system 120 may include two connection ports 154 that are sized and positioned to connect with the outer facing portion 138B of the two disconnect fittings 138. Therefore, as the fluid pump system 120 is moved against the connection assembly 116, the two connection ports 154 and the two outer facing portion 138B of the two disconnect fittings 138 sealingly engage each other to further create a fluid communication path between interior passages of the fluid pump assembly 122 and the interior of the fluid tank 114.

The fluid pump system 120 may connect to one or more spray hoses that may, in turn, be connected to the hand-actuated spray nozzle 102 or a similar attachment. In some examples, either the fluid tank assembly 110 or the fluid pump system 120 may include one or more fluid hose storage mechanisms that help retain and store one or more fluid hoses. In the present example, two hose storage assemblies 160 may be included, such as on each side of the fluid pump assembly 122. In some examples, each of the hose storage assemblies 160 may be in the form of a wheel that may wind and unwind a fluid hose as needed by a user.

In some examples, the two hose storage assemblies 160 may each have a fluid fitting 158 that is coupled with one end of a fluid hose. The fluid fitting 158 may also be connected to a pump fluid fitting 156 on the fluid pump assembly 122, such as by a smaller connection hose (not shown in FIG. 13). In that respect, the hose of each of the two hose storage assemblies 160 may be in fluid communication with an interior passage of the fluid pump assembly 122. This allows the fluid pump assembly 122 to pump fluid out of the hose of one or more of the two hose storage assemblies 160, into the hose of one or more of the two hose storage assemblies 160, or simultaneously into one hose and out of another hose so that fluid can be pumped into the fluid tank 114 and out of the fluid tank 114 simultaneously.

In some examples, the fluid pump system 120 may also be connected to sensors located on or within the fluid tank 114. For example, the fluid tank 114 may include a fluid level sensor, a temperature sensor, a pressure sensor, or similar sensors. The fluid pump system 120 may include electrical connection ports, such as at similar locations as the two connection ports 154, that electrically connect to sensor electrical disconnects of the fluid tank assembly 110. This may allow the fluid pump system 120 to connect and receive sensor data when the fluid pump system 120 is connected to the fluid tank assembly 110.

As best seen in FIG. 4, the fluid pump system 120 may include a power receptacle 168 that may be connected to a power cord and power supply to provide power to the fluid pump system 120, including the fluid pump assembly 122. Additionally, the fluid pump system 120 may include a control panel 152 that may be in electrical communication with the fluid pump assembly 122 to control operations of the pump (e.g., spraying and/or filling), as well as may receive and display sensor data if sensors are present. By providing the power receptacle 168 and control panel 152 on the fluid pump system 120, the fluid pump system 120 may be used in a first configuration attached to the fluid tank assembly 110 and also in a second configuration alone. For example, in the second configuration, one of the hoses from one of the two hose storage assemblies 160 may be placed in a water source (e.g., a pond or other container) and the fluid pump assembly 122 may be adjusted to suction water from that source and then spray out of the other hose of the two hose storage assemblies 160. This may provide more flexibility in operational usage of the mobile spray system 100.

In some examples, the mobile spray system 100 may be configured to and be capable of pumping in one or more, or all of the following states: 1) suction fluid with one hose while spraying with another while bypassing the fluid tank 114, 2) only suctioning and filling the fluid tank 114 with fluid, 3) suctioning and filing the fluid tank 114 with fluid with a first hose while also spraying fluid from the fluid tank 114 with a second hose, 4) recirculating fluid between the top fitting 140 and bottom fitting 142, and 5) only spraying fluid from the fluid tank 114.

Several different configurations of pumps assemblies may be capable of performing some or all of these functions. One example is described in more detail below.

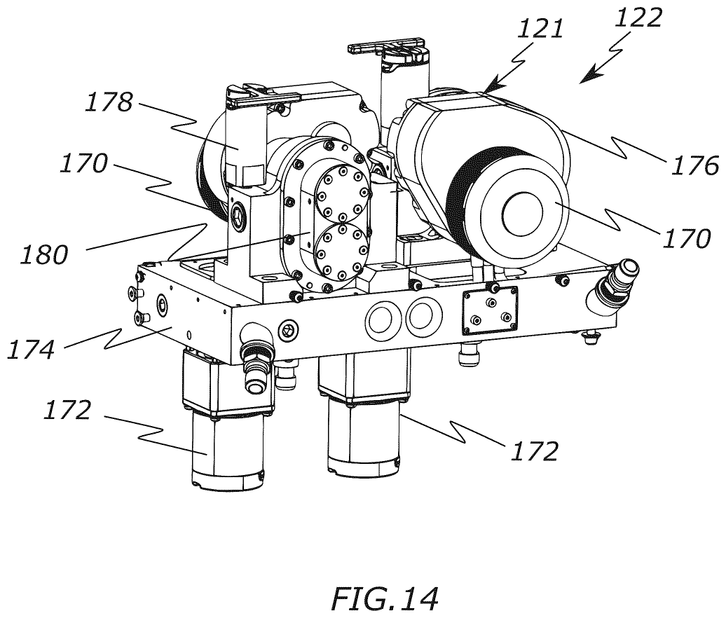

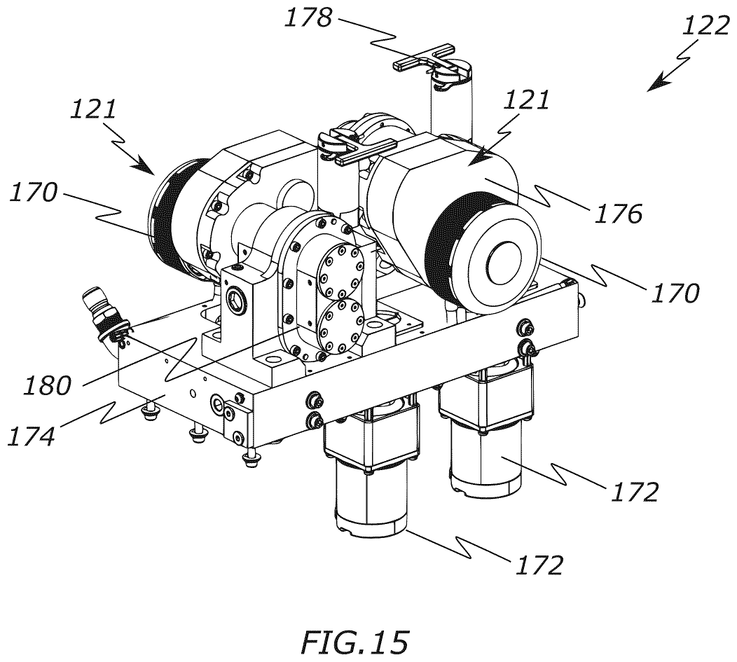

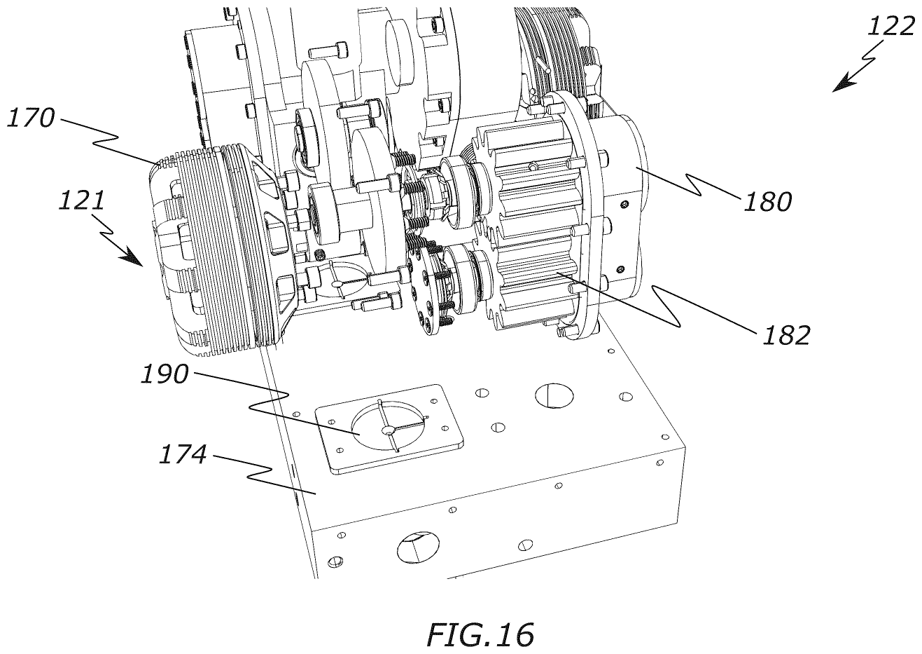

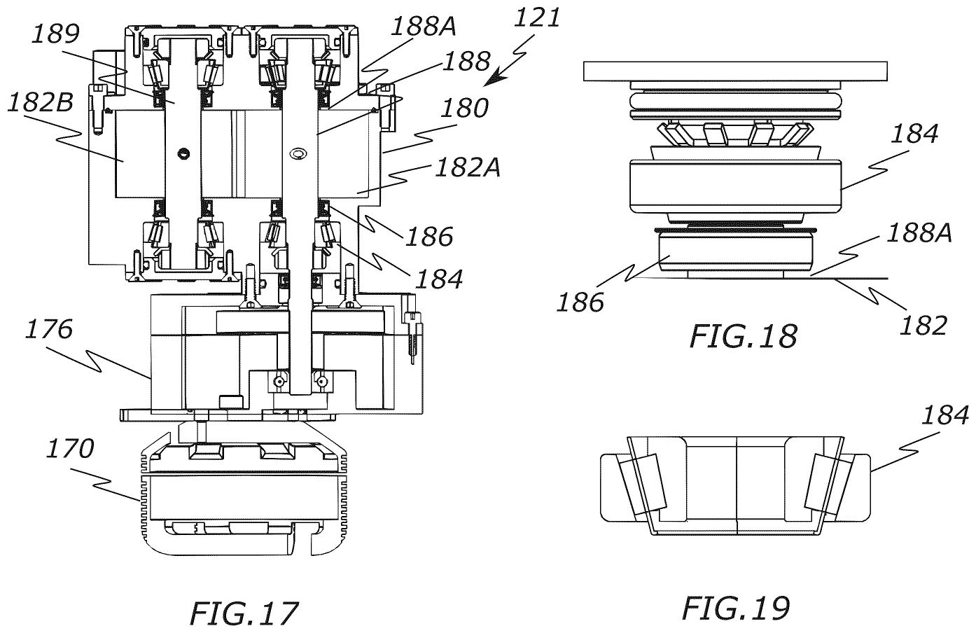

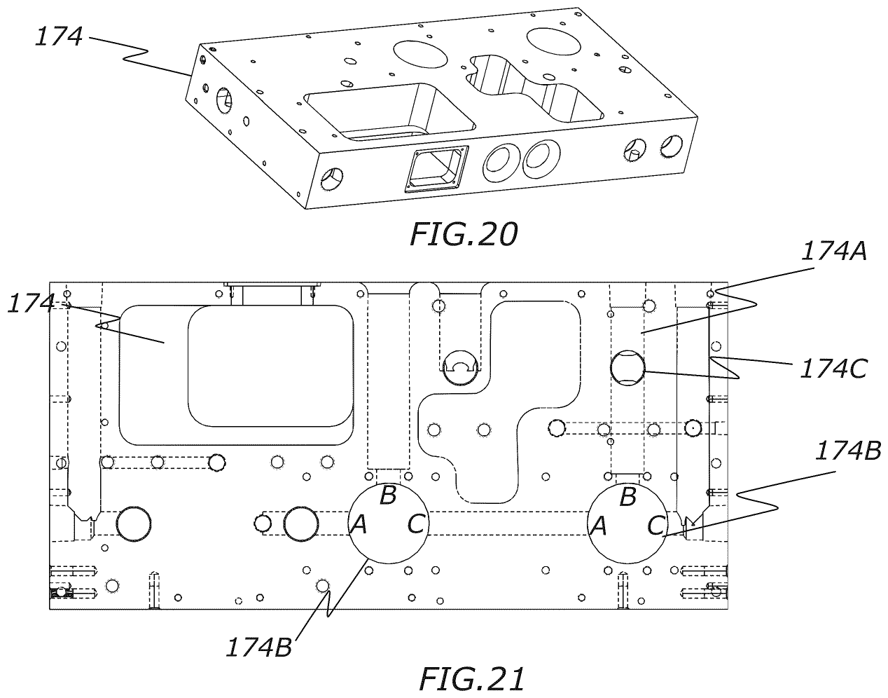

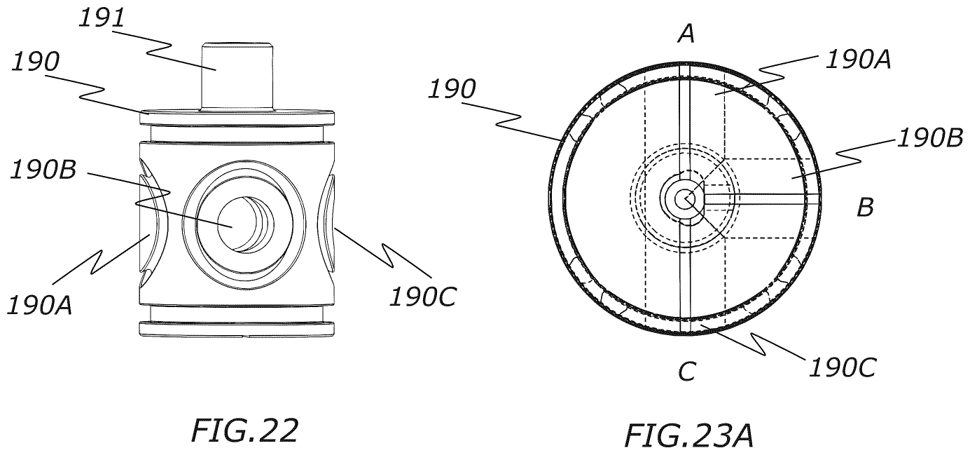

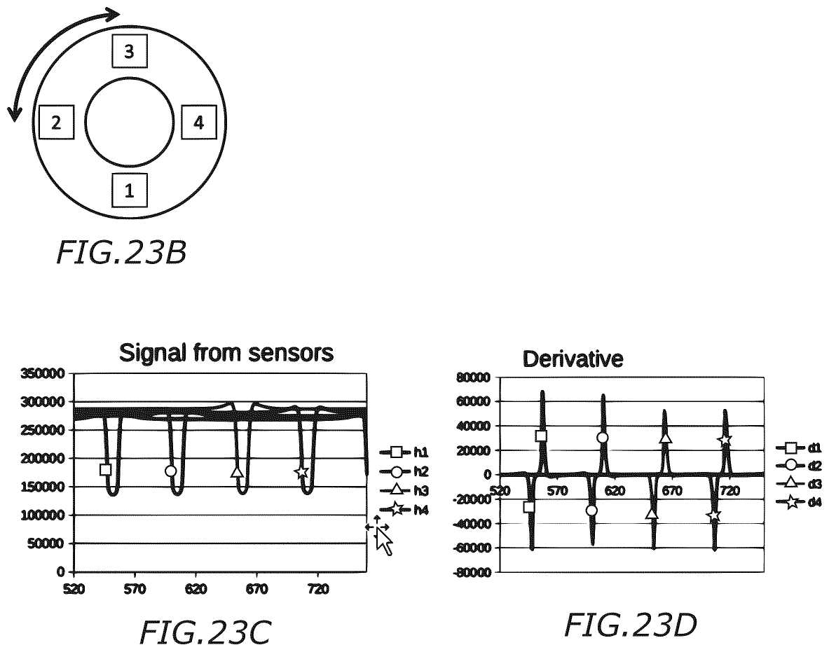

FIGS. 14-21 illustrate various aspects of the fluid pump assembly 122 and its various components. FIG. 14 illustrates an isometric view of a first side of some internal components of the fluid pump assembly 122. FIG. 15 illustrates an isometric view of a second side of some internal components of the fluid pump assembly 122. FIG. 16 illustrates an isometric view of a second side of some internal components of the fluid pump assembly 122. FIG. 17 illustrates a cross-sectional view of some internal components of the fluid pump assembly 122. FIG. 18 illustrates a view of a tapered bearing 184 and a seal 186. FIG. 19 illustrates a cross-sectional view of the tapered bearing 184. FIG. 20 illustrates an isometric view of a manifold block 174. FIG. 21 illustrates a top transparent view of the manifold block 174. FIG. 22 illustrates a side view of a valve member 190. FIG. 23A illustrates a top transparent view of the valve member 190. These figures will be discussed concurrently below.

In some examples, the fluid pump assembly 122 may include two pumps 121 and two valve members 190 to achieve some or all of the previously described pump functionality. Each pump may include a pump motor 170, a pumping gear assembly 180, and a linkage assembly 176. The pump motor 170 may include an output shaft that is coupled to the linkage assembly 176, which is then connected to and drives rotation of components of the pumping gear assembly 180. A gear pump may provide a steady and continuous stream of fluid, can be operated in both directions, and may have a greater reliability and lifespan, especially if fluid may occasionally contain sediment or other particles.

In the present example, the linkage assembly 176 may be coupled to a first shaft 188 that is coupled to a first pump gear 182A. The first pump gear 182A may be engaged or meshed with a second pump gear 182B that is coupled on a second shaft 189. The pumping gear assembly 180 may have two openings into its housing such that when the first pump gear 182A and second pump gear 182B rotate, they drive fluid in through one opening and out of the other, depending on the direction the first pump gear 182A and second pump gear 182B rotate.

In some examples, any or all of these components may be composed of durable materials to improve reliability and pump lifespan. For example, many or all of the components may be composed of or clad with hardened stainless steel. The nature of using a gear pump arrangement allows for most of the components to be composed of such hardened material and therefore may be more durable.

Both the first shaft 188 and second shaft 189 may have each end within the pumping gear assembly 180 supported by a bearing, such as a tapered bearing 184 that is adjacent to a seal 186. In the present example, each tapered bearing 184 may narrow towards the first pump gear 182A or second pump gear 182B (or vice versa) and engage tapered regions on the first shaft 188 or second shaft 189 to better maintain axial positioning and of the first pump gear 182A and second pump gear 182B. In some examples, a small gap 188A may be maintained between the seal 186 and each of the pump gears 182, which may help reduce wear on the seal 186 and leakage over long term use. Additionally, each two pumps 121 may include an oil priming port 178 for that connects to the internal cavity of the pumping gear assembly 180 to provide oil to the pump gears 182 and other components.

Each of the two passages of each pumping gear assembly 180 (four total) may be connected to a pump manifold 174. As best seen in FIG. 21, the manifold block 174 may include four pump openings 174C that each connect to one of those two passages and further open into a series of fluid passages 174A that are depicted with broken lines. This allows each pumping gear assembly 180 to pump fluid between two of the four pump openings 174C.

The fluid passages 174A may be connected to two port blocks 174B (i.e., valve openings) which each contain the valve member 190 seen in FIGS. 22 and 23. Each valve member 190 may include a fluid passage 192, seen with broken lines in FIG. 23A, that direct fluid flow through the 174A, depending on their rotational orientation. Each valve member 190 may be connected to a valve motor 172 that, when activated, rotates the valve member 190 to achieve a desired fluid path configuration through the manifold block 174. In the present example, the valve member 190 may have a “T” passage in which three openings open from the fluid passage 192 to an outside at various locations (e.g., 90 degrees from each other, sequentially). The valve member 190 may have a cylindrical body in some examples, as seen in the figures.

This arrangement provides direct integration of each valve member 190 to the manifold block 174. This direct integration may provide improved reliability by allowing for more components to be composed of hardened materials that may be better resistant to chemicals and particles that may be pumped through the system. Leakage related to these moving components may also be reduced, especially when compared with other designs in which the valves are not included in a manifold.

The control panel 152, which may include a processor or microcontroller configured to execute software/firmware, may be in communication with each valve motor 172 and therefore may selectively energize each valve motor 172 as needed to cause each valve member 190 to independently rotate. The control panel 152 may be aware of the rotational position of each opening of the fluid passage 192 within the valve member 190 and therefore which passages of the manifold block 174 are open or closed to each other. In this manner, fluid passages through the manifold block 174 may be controlled by the control panel 152.

FIG. 21 illustrates manifold 174 including a port block 174B that defines three fixed openings (ports A, B, C). A valve member 190 (e.g., a rotary valve member, FIG. 23A) is mounted coaxially relative to port block 174B and is configured for continuous 360° rotation about a central axis. The assembly is indexable or positionable to four discrete flow states separated by, in some examples, about 90° (nominally 0°, 90°, 180°,270°); where each state establishes a distinct connection pattern among ports A, B, C of the stationary body of the manifold block 174 and port block 174B.

The stationary valve body is not limited to the geometry of manifold 174/port block 174B. In other examples it may be implemented as a cartridge, plate, insert, or block of different shape, provided that it (i) mates with the cylindrical rotary valve member 190 along a sealing interface, (ii) presents three fixed openings distributed about the rotation axis at approximately 0°, 90°, and 180° (i.e., successive ˜90° offsets, with manufacturing tolerances), and (iii) connects to external fluid lines. Equivalent port-face layouts that satisfy these conditions are contemplated.

The rotatable valve member 190 integrates a fluid passage 192 (e.g., that is generally “T” shaped, terminating in three openings 190A, 190B, and 190C. When valve member 190 rotates against the sealing face of the stationary body (e.g., port block 174B), the openings 190A, 190B, 190C re-register with ports A, B, and C of the port block 174B (FIG. 21) to realize the four flow states. Seats and gaskets between valve member 190 and the manifold block 174 permit full circumferential motion without mechanical detents while maintaining fluid isolation. A motor 172 may drive the rotation of the valve member 190 via a shaft 191.

In the present example, the valve members 190 and fluid passages 174A of the manifold block 174 are generally positioned all along a single plane. However, in other examples, the valve member 190 and portions of the fluid passages 174A may be located at different heights and/or planes, which may help reduce the size and footprint of the fluid pump system 120. For example, the manifold block 174 may have two segments that are perpendicular to each other to form a connected “L” shape or a single smaller cube or cuboid block may have fluid passages 174A that have a vertical height component.

In some temperature conditions (e.g., extreme heat or cold), the signal sensed by a Hall Effect sensor may be higher or lower at a specific rotation position, thereby losing accuracy. In that respect, the processing system of the mobile spray system 100 may include an algorithm to calibrate itself. In one example, the algorithm may be executed by the control panel 152 to activate the valve motor 172 so that the valve member 190 may be rotated one or more times. Depending on the magnet configuration, the signal from the Hall Effect sensor may increase and decrease as the valve member 190 rotates. After collection of the raw sensor data, a derivative may be calculated to find a zero point in the sensor data. This zero point may then be correlated relative to the position of the position of the magnet and therefore the openings of the fluid passage 192. Other calibration techniques are also possible, such as using additional sensors and sensor types (e.g., an optical sensor).

In one example, a magnetic ring may be fixed to the shaft 191 and carries a single permanent magnet. Four Hall-effect sensors may be mounted on a control PCB at circumferential locations corresponding to the four indexed positions (such as at about 90° spacing and numbered 1-4 in FIG. 23B). As the magnet passes each sensor, a characteristic low-to-high-to-low waveform is produced, as seen in FIG. 23C, enabling non-contact position sensing and allowing the wetted manifold (including the stationary body) to be sealed for moisture protection.

The control PCB communicates with the Hall-effect sensors and the valve motor 172, and includes a processor configured to: determine angular position of valve member 190 from the Hall-effect sensor outputs; control/actuate rotational alignment of valve member 190 with a selected one of the four flow states on the manifold block 174 (e.g., A, B, C); and provide real-time position feedback (e.g., via UART, I²C, or CAN).

To achieve robust alignment, the firmware may compute a slope (first derivative) of at least one Hall-signal amplitude versus time/angle and detects a zero-slope (with optional sign-change confirmation) indicative of the on-target alignment with the selected state, as seen in FIG. 23D. Optional filtering and hysteresis reduce noise sensitivity. Calibration may periodically rotate through the four states to update a reference Hall profile (e.g., at startup of the fluid pump system 120 or other times during use).

In some examples, a single magnet fixed to and rotating with the valve member 190 is sufficient to sense rotational position and thereby infer which passages are open or closed. To enhance robustness (e.g., against temperature drift, vibration, or mechanical tolerance stack-up), multi-magnet configurations may be employed. For example, a ring carrying two or four magnets can be fixed to the valve member 190; magnets may be located proximate to each flow opening and/or the corresponding “closed” alignments to provide absolute position encoding; and the magnets may be differentiated by polarity, spacing, or strength so their signatures are distinguishable. In some embodiments, magnets of different materials (e.g., NdFeB and SmCo) are combined to leverage their different temperature coefficients, thereby providing redundancy and partial temperature compensation. Any of these options may be used singly or in combination while preserving non-contact magnetic sensing.

In some temperature conditions (e.g., extreme heat or cold), the signal sensed by a Hall Effect sensor may be higher or lower at a specific rotation position, thereby losing accuracy. In that respect, the processing system of the mobile spray system 100 may include an algorithm to calibrate itself. In one example, the algorithm may be executed by the control panel 152 to activate the valve motor 172 so that the valve member 190 may be rotated one or more times. Depending on the magnet configuration, the signal from the Hall Effect sensor may increase and decrease as the valve member 190 rotates. After collection of the raw sensor data, a derivative may be calculated to find a zero point in the sensor data. This zero point may then be correlated relative to the position of the position of the magnet and therefore the openings of the fluid passage 192. Other calibration techniques are also possible, such as using additional sensors and sensor types (e.g., an optical sensor).

The manifold block 174 may be composed of a hardened material, such as hardened stainless steel to improve durability and longevity. Alternatively, the manifold block 174 may be composed of a polymer or similar material. Additionally, the fluid passages 174A, two port blocks 174B, and four pump openings 174C may be formed into a solid block of material, such as by molding, engraving, drilling, and/or similar processes. By using a manifold block 174 formed from a single block of material, leaks may be reduced, especially if compared with solely using hoses and fittings.

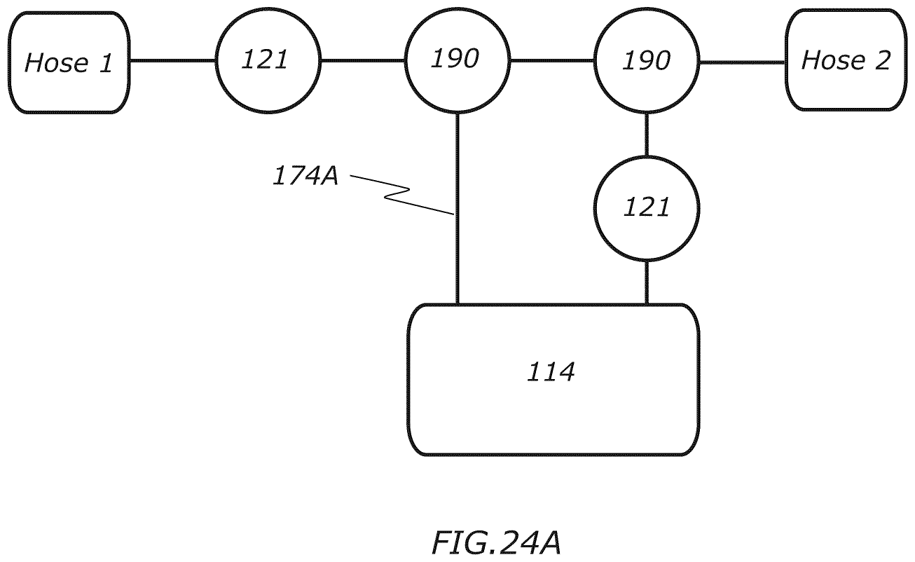

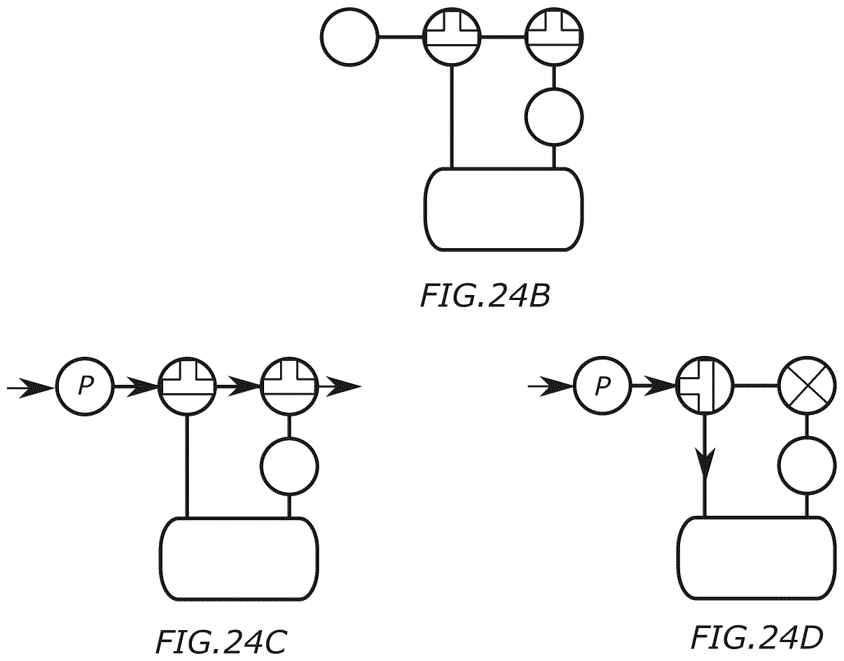

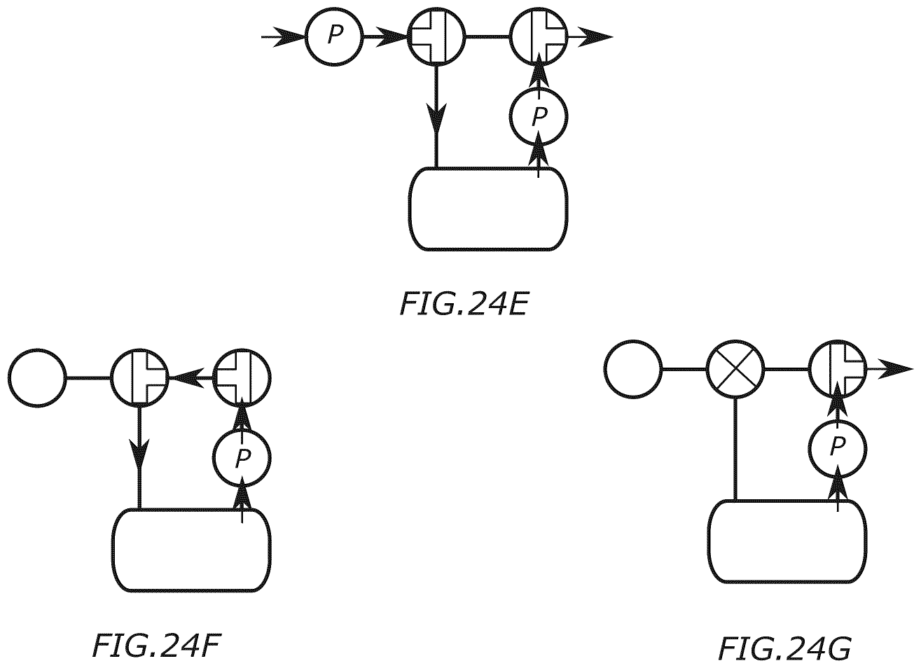

FIG. 24A illustrates a simplified schematic of the fluid passages 174A of the manifold block 174, as well as each valve member 190, each valve motor 172, and the fluid tank 114 to help illustrate some example configurations and functionalities of the mobile spray system 100 in the following figures. A “P” in the following figures indicates that a two pump 121 is activated, an “X” indicates a valve member 190 is closed or that the position does not matter in a usage scenario, a “T” shape indicates an open position of the fluid passage 192 of the valve member 190, and arrows indicate a direction of fluid passage.

FIG. 24B illustrates a simplified schematic view of the mobile spray system 100 in an off or powered down state. FIG. 24C illustrates a simplified schematic view of the mobile spray system 100 in a passthrough state in which fluid is sucked into the fluid pump system 120 and sprayed out of the fluid pump system 120, bypassing the fluid tank 114. FIG. 24D illustrates a simplified schematic view of the mobile spray system 100 in a fill state in which fluid is pumped from outside of the fluid pump system 120 and into the fluid tank 114. FIG. 24E illustrates a simplified schematic view of the mobile spray system 100 in a fill/spray state in which fluid outside of the fluid pump system 120 is pumped into the fluid tank 114 and fluid within the fluid tank 114 is also simultaneously pumped out of the fluid tank 114 to spray. FIG. 24F illustrates a simplified schematic view of the mobile spray system 100 in a recirculate state in which the fluid pump system 120 pumps fluid out of the fluid tank 114 and back into the fluid tank 114 (e.g., to mix contents of the fluid tank 114). FIG. 24G illustrates a simplified schematic view of the mobile spray system 100 in which the fluid pump system 120 pumps fluid from the fluid tank 114 to spray.

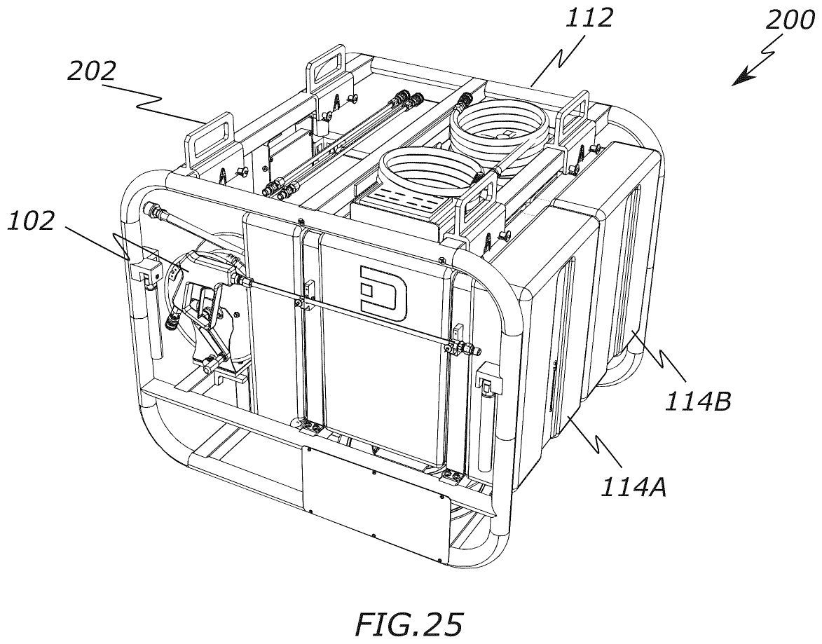

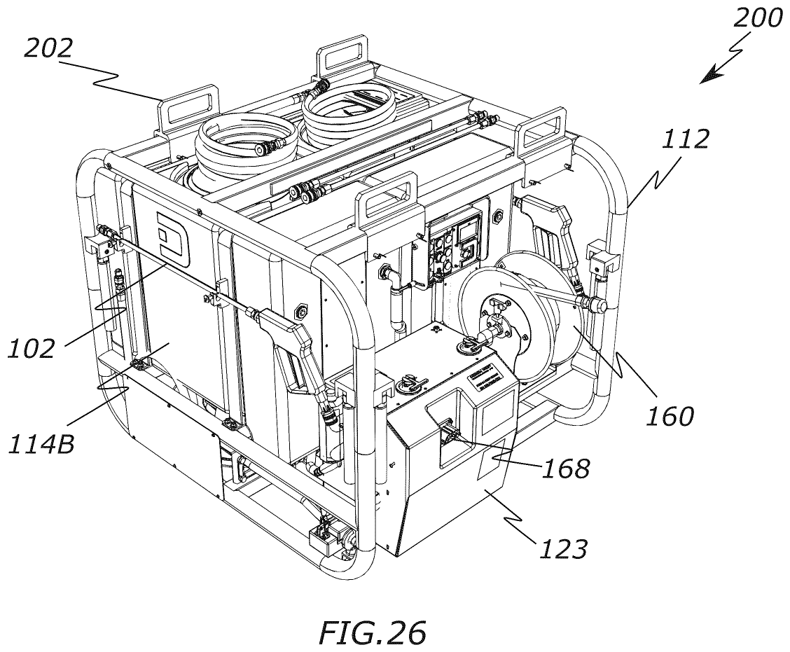

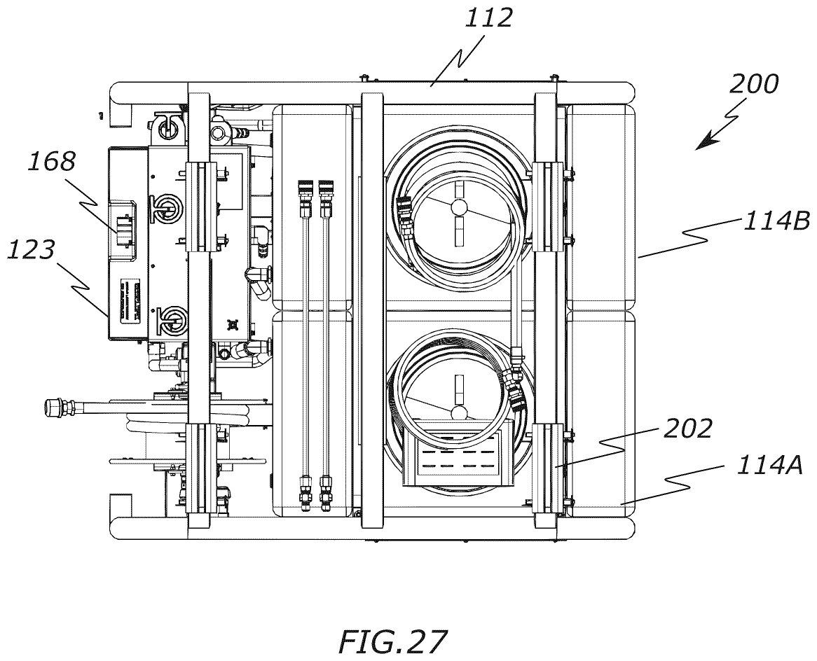

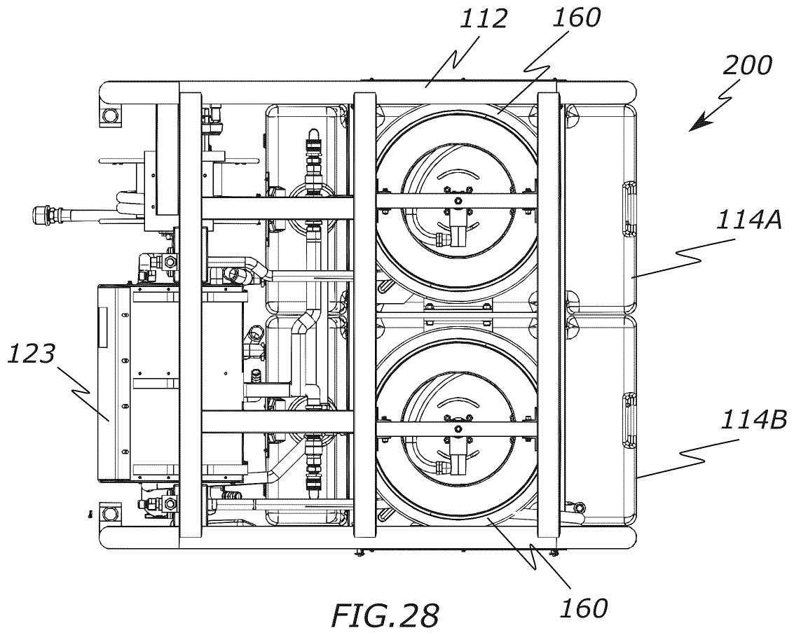

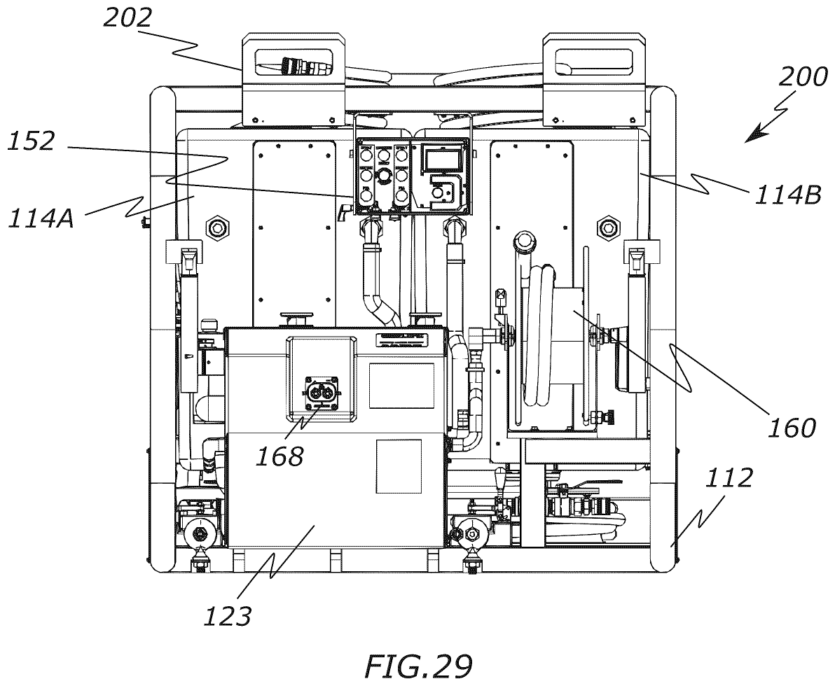

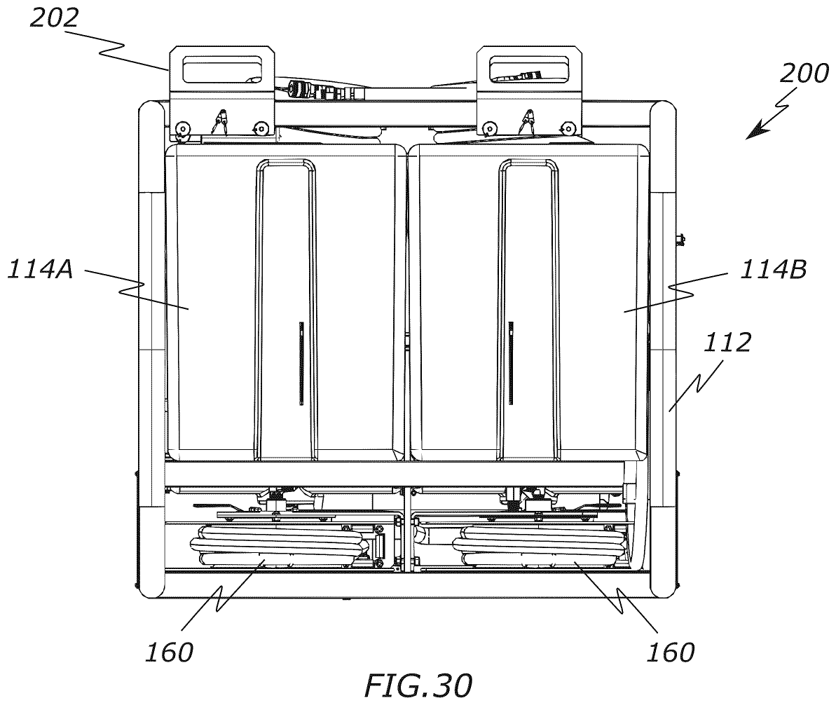

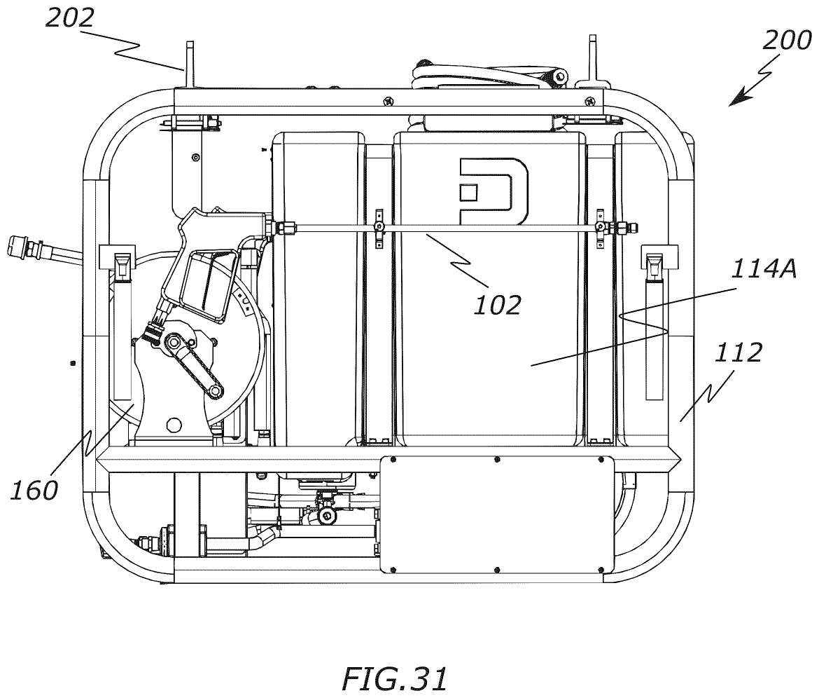

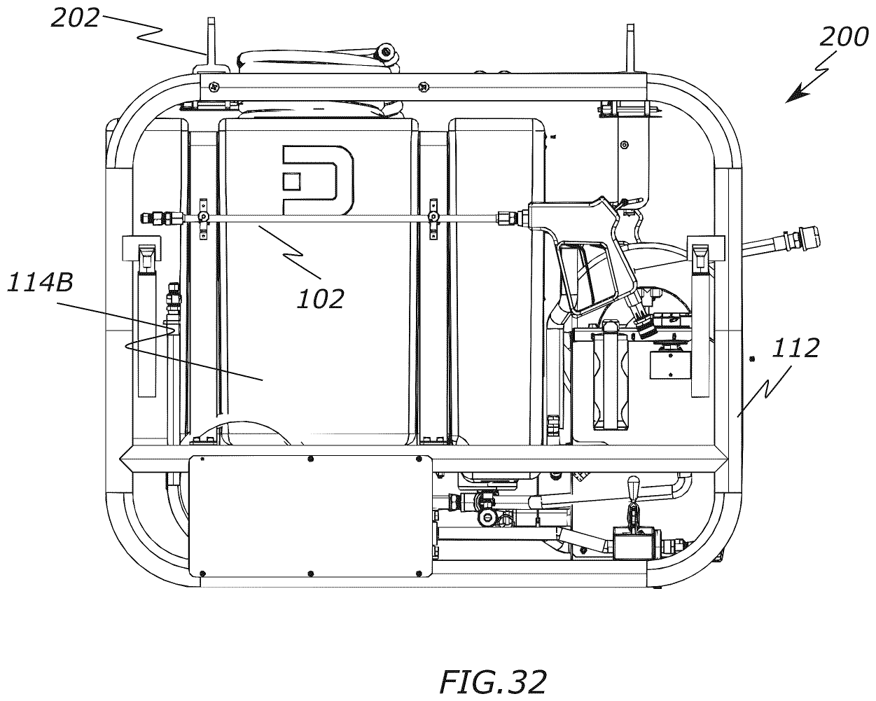

FIGS. 29-32 illustrate another example of a mobile spray system 200 that is generally similar to the mobile spray system 100. FIG. 25 illustrates an isometric view of the mobile spray system 200. FIG. 26 illustrates another isometric view of the mobile spray system 200. FIG. 27 illustrates a top view of the mobile spray system 200. FIG. 28 illustrates a bottom view of the mobile spray system 200. FIG. 29 illustrates a front view of the mobile spray system 200. FIG. 30 illustrates a back view of the mobile spray system 200. FIG. 31 illustrates a side view of the mobile spray system 200. FIG. 32 illustrates another side view of the mobile spray system 200. These figures are discussed concurrently below.

The mobile spray system 200 may have several differences from the previously described mobile spray system 100, any of which may be mixed and matched with features of the mobile spray system 100. First, the mobile spray system 200 may have a first fluid tank 114A and a second fluid tank 114B. This may allow for further uses and functionality of filling, pumping, and recirculation of the mobile spray system 200, as discussed later. In the present example, the first fluid tank 114A and second fluid tank 114B are positioned vertically along side each other, however they may be stacked vertically as well. The structural frame 112 may also be larger to accommodate the first fluid tank 114A and second fluid tank 114B.

Additionally, the mobile spray system 200 may have three of the hose storage assemblies 160. One on the front (FIG. 26) and two on the bottom (FIG. 28). However, other numbers of hose storage assemblies 160 may also be possible (e.g., 2 or 4).

The structural frame 112 may also have several forklift brackets 202 which are sized and positioned for receiving tines of a forklift through them. This allows a forklift to easily pick up the mobile spray system 200 and move it to a desired location. In one example, the several forklift brackets 202 have a generally rectangular opening through them that is slightly larger than a forklift tine, however, a single larger bracket with a single rectangular opening is also possible.

Unlike the mobile spray system 100, the fluid pump assembly 123 is not selectively removable, though such an arrangement is possible on this example as well.

The fluid pump assembly 123 may be generally similar to the fluid pump assembly 122 except that it may accommodate two fluid connections/passage into the first fluid tank 114A and second fluid tank 114B.

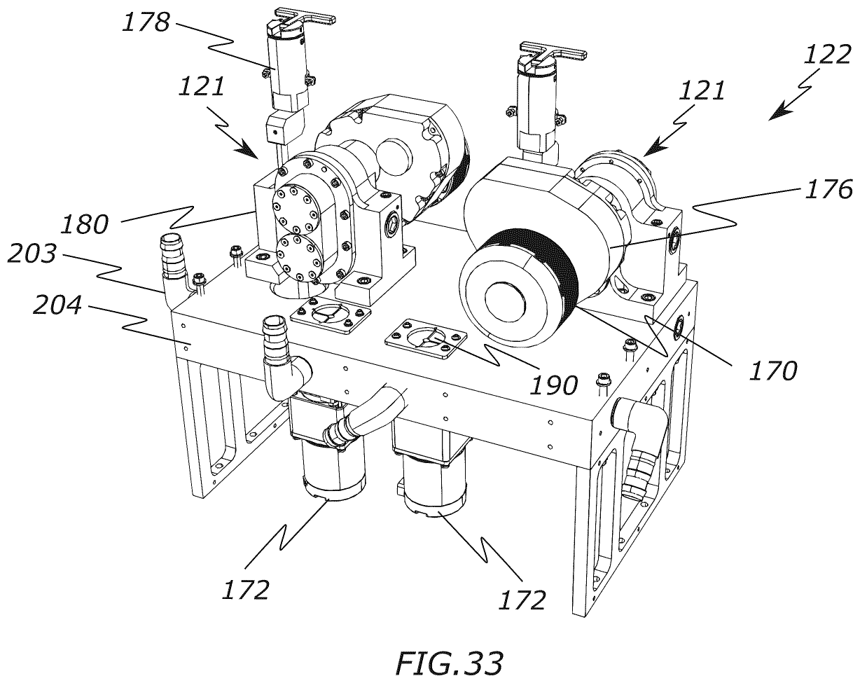

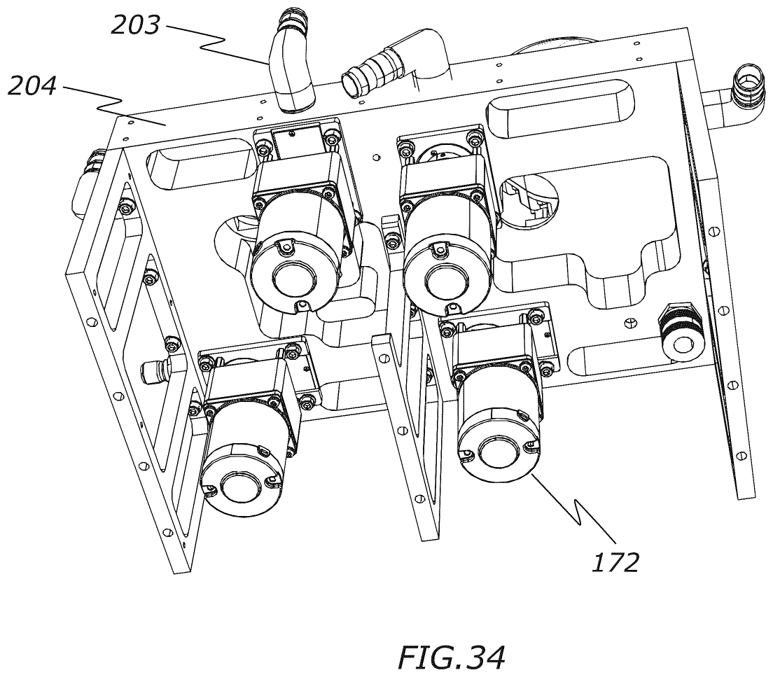

FIG. 33 illustrates a top isometric view of the internal components of the fluid pump assembly 123 and FIG. 34 illustrates a bottom isometric view of the internal components of the fluid pump assembly 123. The fluid pump assembly 123 may include two pumps 121 but may further have four valve motors 172 that accommodate the four inlet/outlets/connections 203 on the sides of the manifold block 204.

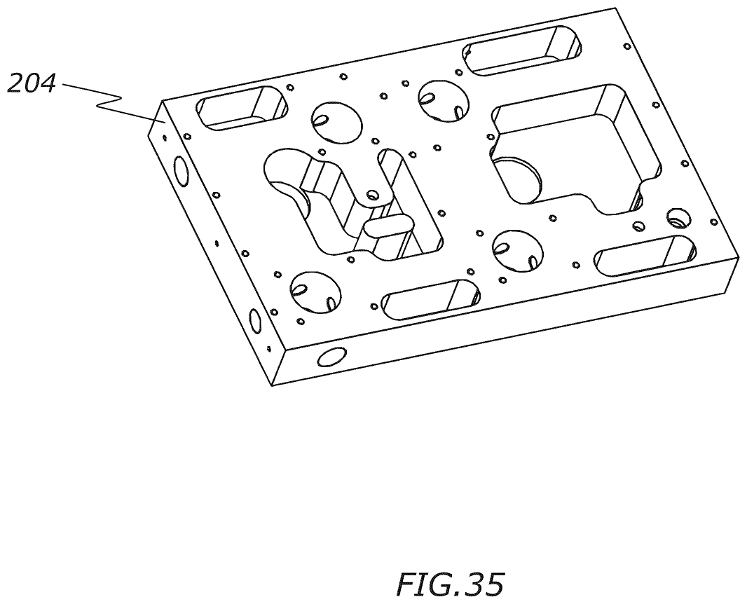

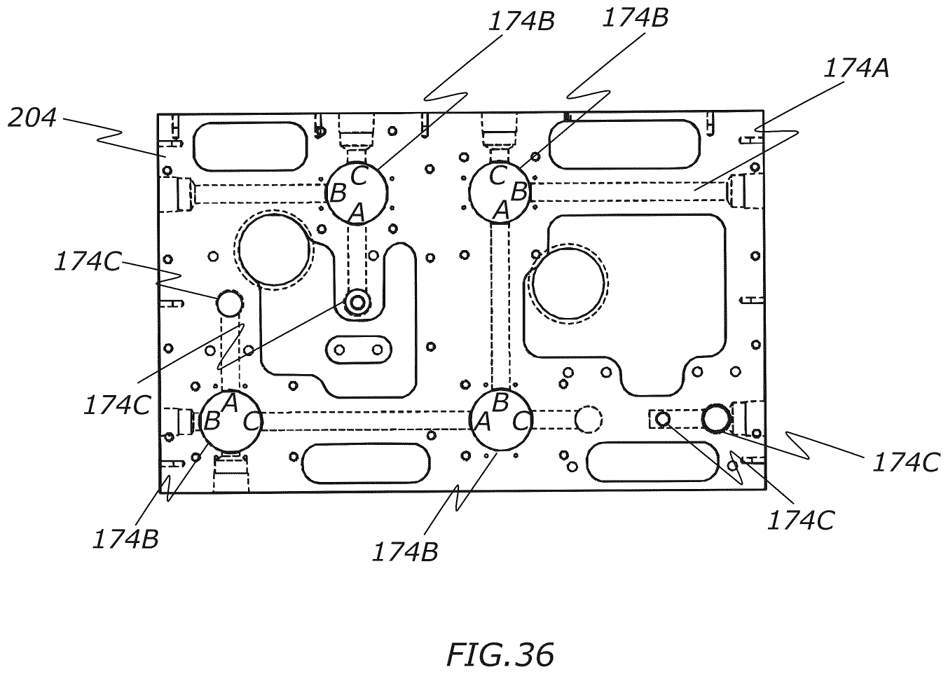

The manifold block 204 can be best seen in the isometric view of FIG. 35 and the transparent view of FIG. 36. Again, the fluid passages 174A can be seen as broken lines that connect to four port blocks 174B and four pump openings 174C, in a similar manner to the manifold block 174 of the mobile spray system 100. The four port blocks 174B may each include a valve member 190, similar to that previously discussed.

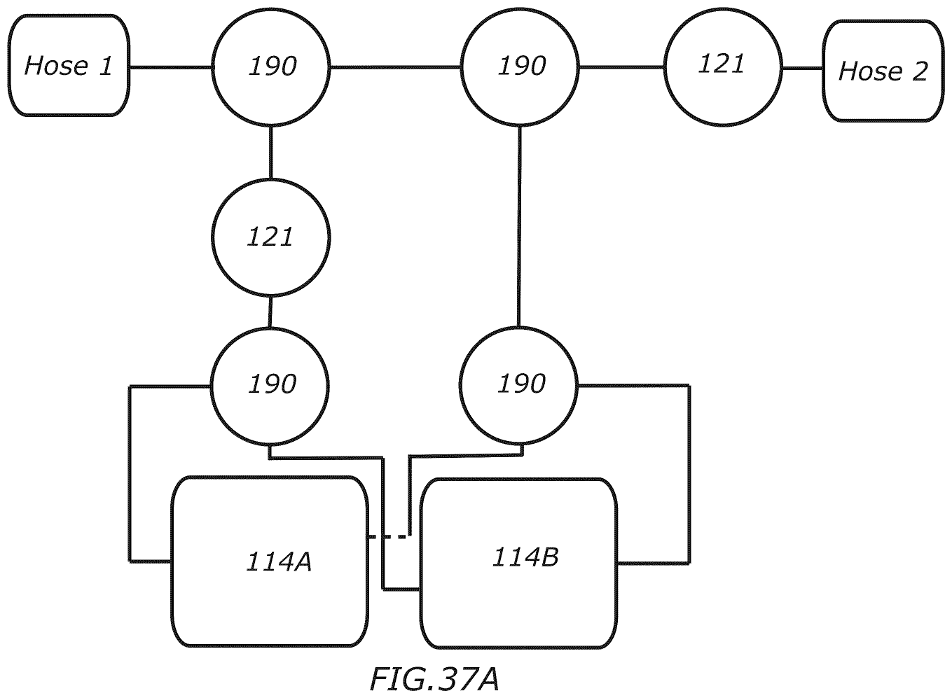

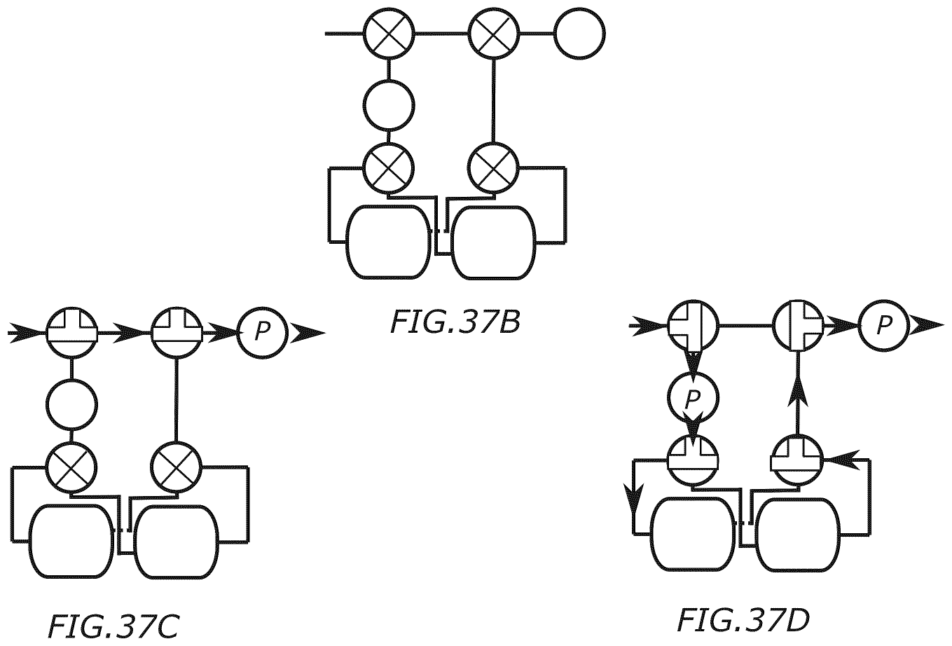

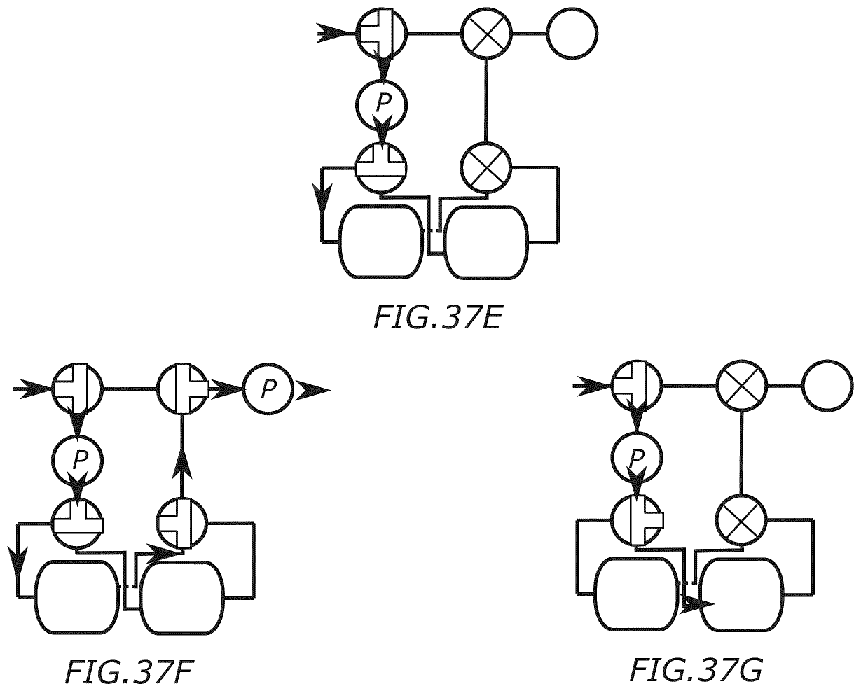

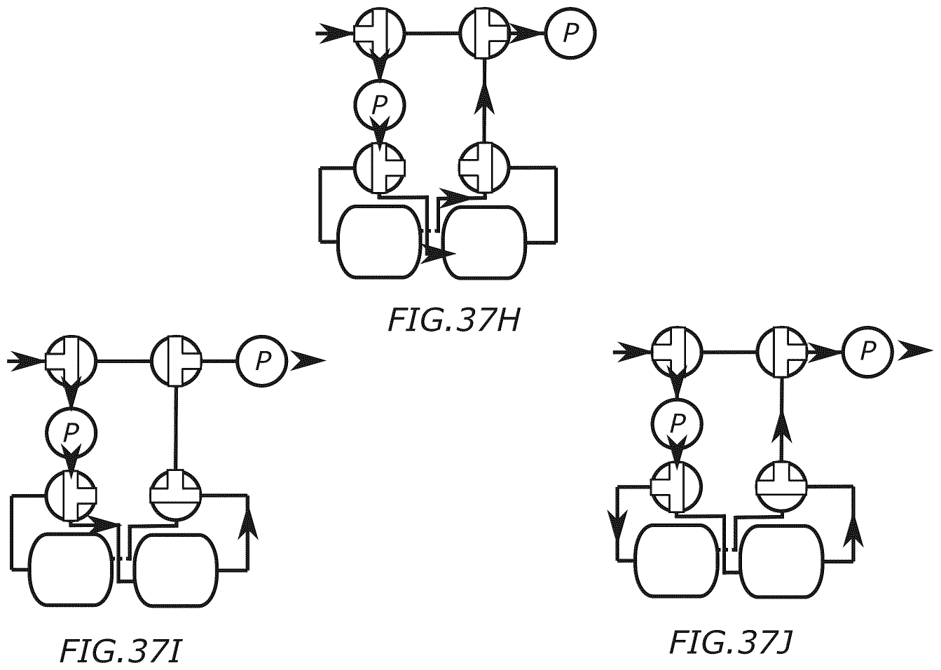

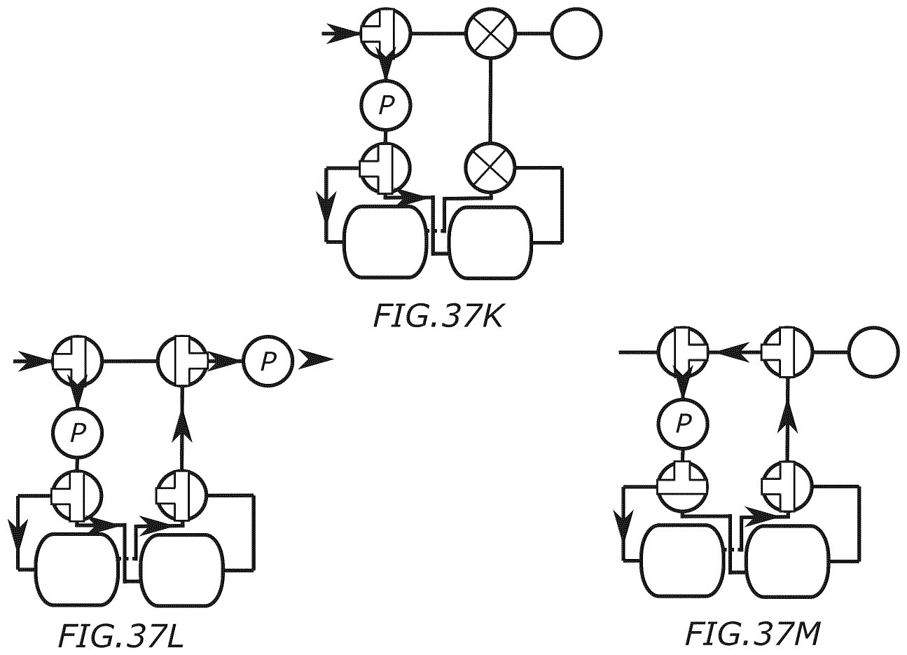

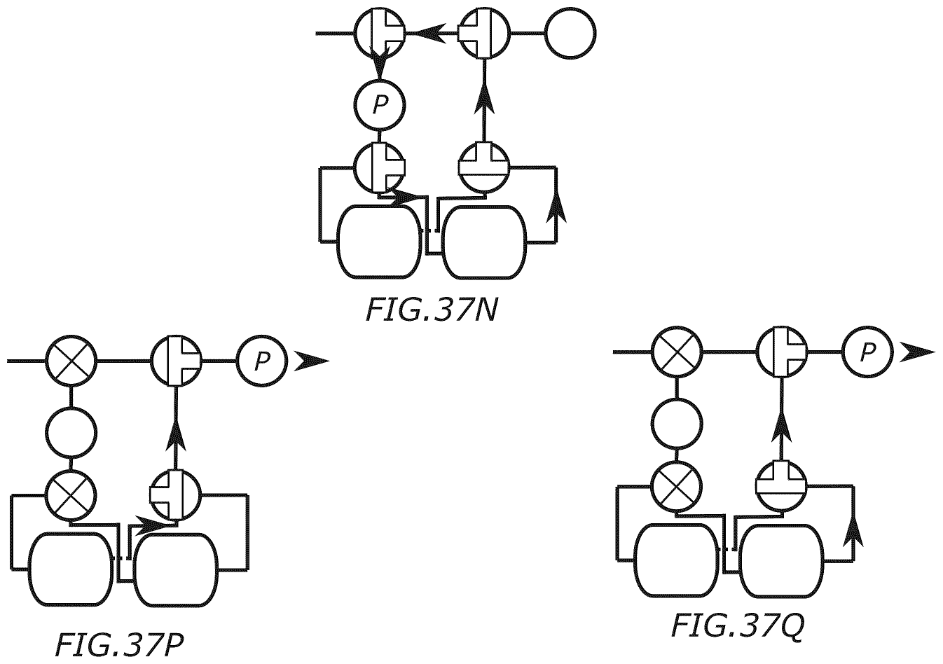

With four valve members 190 and two fluid connections to the first fluid tank 114A and second fluid tank 114B (e.g., via connections 203), the mobile spray system 200 may perform several combinations of spraying, filling, and/or recirculation. FIG. 37A illustrates a simplified schematic of the fluid passages 174A of the manifold block 204, as well as each valve member 190, each valve motor 172, the first fluid tank 114A, and second fluid tank 114B to help illustrate some example configurations and functionalities of the mobile spray system 200 in the following figures. A “P” in the following figures indicates that a two pump 121 is activated, an “X” indicates a valve member 190 is closed or that the position does not otherwise matter, a “T” shape indicates an open position of the fluid passage 192 of the valve member 190, and arrows indicate a direction of fluid passage.

FIG. 37B illustrates a simplified schematic view of the mobile spray system 200 in an off or powered down state. FIG. 37C illustrates a simplified schematic view of the mobile spray system 200 in a bypass state that suctions fluid into and out of the fluid pump assembly 123 while bypassing the first fluid tank 114A and second fluid tank 114B. FIG. 37C illustrates a simplified schematic view of the mobile spray system 200 in a filling and spraying state. FIG. 37D illustrates a simplified schematic view of the mobile spray system 200 in a tank-filling and spraying state. FIG. 37E illustrates a simplified schematic view of the mobile spray system 200 in a tank-filling. FIG. 37F illustrates a simplified schematic view of the mobile spray system 200 in a tank-filling and spraying state. FIG. 37G illustrates a simplified schematic view of the mobile spray system 200 in tank-filling. FIG. 37H illustrates a simplified schematic view of the mobile spray system 200 in a tank-filling and spraying state. FIG. 37I illustrates a simplified schematic view of the mobile spray system 200 in a tank-filling and spraying state. FIG. 37J illustrates a simplified schematic view of the mobile spray system 200 in a tank filling and spraying. FIG. 37K illustrates a simplified schematic view of the mobile spray system 200 in a filling state. FIG. 37L illustrates a simplified schematic view of the mobile spray system 200 in a filling and spraying state. FIG. 37M illustrates a simplified schematic view of the mobile spray system 200 in a recirculating state. FIG. 37N illustrates a simplified schematic view of the mobile spray system 200 in a recirculation state. FIG. 37P illustrates a simplified schematic view of the mobile spray system 200 in a spraying state. FIG. 37Q illustrates a simplified schematic view of the mobile spray system 200 in a spraying state.

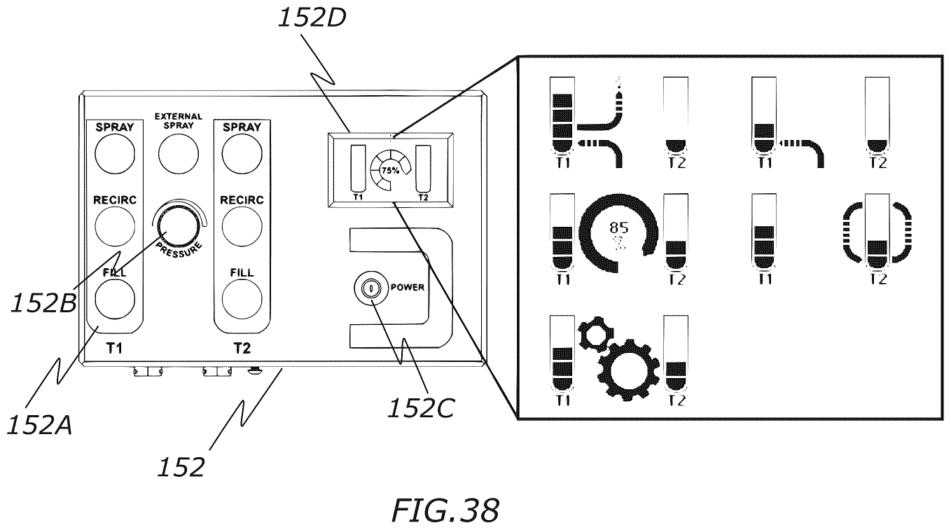

FIG. 38 illustrates an enlarged view of the control panel 152 which, in some examples may include push buttons to control the manifold function, including filling, recirculation, and spraying. In some examples, the control panel 152 may include four buttons, including filling, recirculation, spraying from tank, and spraying from source. In another example, there are seven buttons, as shown in FIG. 38. A further enlarged view of a display showing a graphic indication of the function may also be included 1) filling and spraying, 2) filling, 3) spraying speed control ,4) recirculation, and 5) indicating valve moving.

In some examples, the control panel 152 may implement a one-button trigger interface. The control panel 152 may present seven dedicated function buttons 152A, such as SPRAY (T1), RECIRC (T1), FILL (T1), EXTERNAL SPRAY, SPRAY (T2), RECIRC (T2), and FILL (T2), where T1 represents functions for a first tank and T2 represents functions for a second tank. Actuation of any one button 152A causes a controller on the control PCB to automatically coordinate valve member 190 positioning via the valve motors 172 and actuation of the two pumps 121 for moving fluid, without further user selections. The panel may further include a fluid pressure control input 152B, a power control 152C, and a tank/status display 152D. A set of pictograms is rendered on the adjacent display to indicate the active mode and progress.

As an example, when the user presses the FILL (T1) button, the controller executes a predefined routine that:
verifies interlocks and available fluid supply (e.g., via a tank fluid level sensor);
rotates the three-way, four-position rotary valve member 190 to the T1 filling position as shown in FIG. 37E using, for example, the previously described Hall-sensor alignment method
energizes the designated fluid pump 121 and holds other pumps/valves closed as needed;
monitors fluid level/pressure and regulates flow (e.g., soft start, current/pressure limits);
renders the “FILL (T1)” pictogram (icon 37) and a progress indicator (e.g., percentage complete);
terminates filling upon reaching a target level or a safety condition, and reports final state.

Variations include mapping other buttons to corresponding routines (e.g., RECIRC, SPRAY, EXTERNAL SPRAY), each routine automatically selecting the appropriate valve position(s) and pump set(s) while providing real-time visual feedback on the display.

Accordingly, the system delivers appliance-level convenience: a one-button trigger selects the desired function, and the controller automatically orchestrates valve positioning, pump actuation, safety interlocks, and progress indication, allowing the operator to focus on the task rather than setup—reducing training, minimizing errors, and providing repeatable results.

What is claimed is:

1. A spray system, comprising:
a fluid tank assembly; and,
a fluid pump system that is releasably connected to the fluid tank assembly.

2. The spray system of claim 1, wherein the fluid tank assembly comprises a fluid tank having a fluid cavity, a first fluid connection, and a second fluid connection.

3. The spray system of claim 2, wherein the fluid pump system comprises a fluid pump assembly including a first pump and a second pump.

4. The spray system of claim 3, wherein the first pump and the second pump are both gear pumps.

5. The spray system of claim 4, wherein the first pump and the second pump each have first and second fluid connections into passages of a manifold block.

6. The spray system of claim 5, wherein the fluid pump assembly comprises a first valve and a second valve, both located within the manifold block and arranged to open and close portions of the passages of the manifold block.

7. The spray system of claim 6, wherein the first valve and the second valve are each a cylindrical valve member that have three openings into a valve passage therethrough.

8. The spray system of claim 2, further comprising a connection assembly that releasably connects the fluid pump system to the fluid tank assembly; the connection assembly comprising a latch mechanism and two fluid disconnect fittings in communication with the fluid tank.

9. The spray system of claim 8, wherein the connection assembly further comprises a slot through a support plate and an alignment rail movable into and out of the slot.

10. The spray system of claim 2, wherein the fluid pump system is configured to simultaneously fill the fluid tank from a first hose and spray fluid from a second hose.

11. The spray system of claim 10, wherein the fluid pump system is further configured to circulate fluid into and out of the fluid tank.

12. A spray system, comprising:
a fluid tank assembly;
a fluid pump system;
a connection assembly configured to releasably connect the fluid pump system to the fluid tank assembly, the connection assembly including a mechanical latch and at least two fluid disconnect fittings;
a flow-routing component configurable among a plurality of flow states to direct fluid between the fluid tank assembly, a supply line, and a spray outlet;
a user interface including a set of one-button function triggers; and
an electronic controller operatively coupled to the user interface, the flow-routing component, and the fluid pump system;
wherein, in response to actuation of any one of the one-button function triggers, the controller automatically configures the flow-routing component and energizes a selected pump or pumps to execute a corresponding function without further user selections.

13. The spray system of claim 11, wherein the connection assembly further comprises a slot through a support plate and an alignment rail movable into and out of the slot to guide attachment and detachment.

14. The spray system of claim 11, wherein the fluid pump system comprises first and second pumps mounted to a manifold block having passages coupled to fluid disconnect fittings.

15. The spray system of claim 14, wherein the first and second pumps are gear pumps.

16. The spray system of any of claim 11, wherein a flow-routing component is selected from the group consisting of a rotary valve, a spool valve, a shuttle valve, and a manifold of on/off valves operated by a single actuator.

17. The spray system of any of claims 11, wherein a controller is configured to simultaneously fill the fluid tank assembly from a first hose and spray fluid from a second hose by commanding a flow-routing component and the pumps accordingly.

18. The spray system of any of claims 11, wherein a controller is further configured to circulate fluid into and out of the fluid tank assembly as a selectable function.

19. The spray system of any of claims 11, wherein a user interface further includes a display that renders a pictogram indicative of an active function and a progress indicator during execution.

20. The spray system of any of claims 1, wherein the fluid tank assembly comprises a fluid tank having a fluid cavity, a first fluid connection, and a second fluid connection, each in fluid communication with fluid disconnect fittings when connected.

21. A three-way, four-position rotary valve assembly, comprising:
a stationary valve body having three fixed ports;
a rotatable valve member disposed within the stationary valve body, the rotatable valve member defining a T-shaped flow passage with three openings configured to re-register with the three fixed ports;
a motor operatively coupled to rotate the rotatable valve member through 360° about a central axis;
a magnetic element fixed to rotate with the rotatable valve member;
four Hall-effect sensors arranged circumferentially about the central axis; and
a control printed circuit board (PCB) in signal communication with the Hall-effect sensors and the motor;
wherein the valve assembly is indexable to four discrete flow states separated by about 90° of rotation, each flow state establishing a distinct connection pattern among the three fixed ports.

22. The valve assembly of claim 21, wherein the four Hall-effect sensors are positioned at angular locations corresponding to the four flow states.

23. The valve assembly of claim 21, wherein the magnetic element comprises a permanent magnet mounted to a magnetic ring fixed to a shaft of the motor or the rotatable valve member.

24. The valve assembly of claim 21, wherein the control PCB determines an angular position of the rotatable valve member based on outputs of the four Hall-effect sensors, commands the motor to align the rotatable valve member with a selected one of the four flow states, and provides real-time position feedback.

25. The valve assembly of claim 21, wherein the Hall-effect sensors and the magnetic element are arranged for non-contact sensing, enabling the valve assembly to be sealed for moisture protection.

26. The valve assembly of claim 21, wherein the four Hall-effect sensors are equally spaced at approximately 90° intervals around the central axis.

27. The valve assembly of claim 21, wherein the control PCB is configured to execute a control method comprising:
receiving a command identifying a target one of the four flow states;
driving the motor to rotate the rotatable valve member;
sampling, during the rotation, signal amplitudes from the Hall-effect sensors as the magnetic element passes each sensor and produces a low-to-high-to-low waveform;
computing a slope (first derivative) of at least one sampled Hall-effect signal and detecting a zero-slope condition indicative of on-target alignment with the target flow state; and
stopping the motor in response to detecting the zero-slope condition.

28. The valve assembly of claim 27, wherein the control PCB applies filtering and/or hysteresis to the Hall-effect signals prior to computing the slope to reduce noise sensitivity.

29. The valve assembly of claim 27, wherein the control PCB adjusts stop timing based on a measured sign change of the slope around the zero-slope condition to compensate for temperature-or friction-induced variation.

30. The valve assembly of any of claims 27, wherein the control PCB periodically performs a calibration by rotating through the four flow states to update a reference profile of Hall-effect signal versus angle.

31. The valve assembly of claim 27, wherein rotation by approximately 0°, 90°, 180°, and 270° produces the four discrete flow states.
